(19) United States
(12) Patent Application Publication
(10) Pub. No.: US 2022/0271288 A1
(43) Pub. Date: Aug. 25, 2022

(54) ARGYRODITE-CONTAINING COMPOSITES

(71) Applicant: Blue Current, Inc., Hayward, CA (US)

(72) Inventors: Joanna Burdynska, Berkeley, CA (US); Kevin Wujcik, Berkeley, CA (US); Simmi Kaur Uppal, Oakland, CA (US); Irune Villaluenga, Berkeley, CA (US); Eduard Nasybulin, Fremont, CA (US); Benjamin Rupert, Hayward, CA (US); Richard Hoft, Palo Alto, CA (US); Katherine Joann Harry, Oakland, CA (US)

(21) Appl. No.: 17/626,092

(22) PCT Filed: Jul. 10, 2020
(86) PCT No.: PCT/US2020/070257

§ 371 Date: Jan. 10, 2022

Related U.S. Application Data
(60) Provisional application No. 62/952,088, filed on Dec. 20, 2019.
(60) Provisional application No. 62/872,673, filed on Jul. 10, 2019.

(51) Int. Cl. H01M 4/58; H01M 4/62; H01M 10/04; H01M 50/414; H01M 4/04; H01M 10/0562; H01M 10/0525

(52) U.S. Cl. CPC H01M 4/5815; H01M 4/622; H01M 10/0468; H01M 2300/0068; H01M 4/0471; H01M 10/0562; H01M 10/0525; H01M 50/414

(57) ABSTRACT

Provided herein are composite materials that include an ionically conductive inorganic solid particulate phase and an organic polymer phase. The ionically conductive inorganic solid particular phase includes an alklai metal argyrodite.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Solid-state electrolytes present various advantages over liquid electrolytes for primary and secondary batteries. For example, in lithium ion secondary batteries, inorganic solid-state electrolytes may be less flammable than conventional liquid organic electrolytes. Solid-state electrolytes can also facilitate use of a lithium metal electrode by resisting dendrite formation. Solid-state electrolytes may also present advantages of high energy densities, good cycling stabilities, and electrochemical stabilities over a range of conditions. However, there are various challenges in large scale commercialization of solid-state electrolytes. One challenge is maintaining contact between electrolyte and the electrodes. For example, while inorganic materials such as inorganic sulfide glasses and ceramics have high ionic conductivities (over 10⁻⁴ S/cm) at room temperature, they do not serve as efficient electrolytes due to poor adhesion to the electrode during battery cycling. Another challenge is that glass and ceramic solid-state conductors are too brittle to be processed into dense, thin films on a large scale. This can result in high bulk electrolyte resistance due to the films being too thick, as well as dendrite formation, due to the presence of voids that allow dendrite penetration. The mechanical properties of even relatively ductile sulfide glasses are not adequate to process the glasses into dense, thin films.

Materials that have high ionic conductivities at room temperature and that are sufficiently compliant to be processed into thin, dense films without sacrificing ionic conductivity are needed for large scale production and commercialization of solid-state batteries.

### SUMMARY

One aspect of the disclosure relates to a method including providing a film including unreacted argyrodite precursor compounds in a polymer; and heating the film to thereby react argyrodite precursor compounds in the film to form argyrodite.

In some embodiments, the method further includes, prior to providing the film, partially reacting argyrodite precursors by mechanochemical mixing to form particles including argyrodite phase and the unreacted argyrodite precursor compounds. In some such embodiments, providing a film including unreacted argyrodite precursor compounds in a polymer includes mixing the particles with the polymer. In some embodiments, the method further includes pressing the film while heating it. In some embodiments, the film is heated to a temperature of no more than 550° C. In some embodiments the argyrodite precursors include Li₂S and LiX wherein X is a halide. In some embodiments, the film including unreacted argyrodite precursor compounds in a polymer has substantially no argyrodite phase. In some embodiments, the film is between 0.5 wt %-60 wt % polymer, 1 wt %-40 wt % polymer, or 5 wt %-30 wt % polymer. In some embodiments, heating the film is performed without thermally degrading the polymer.

Another aspect of the disclosure relates to a method including: providing a film including argyrodite-containing particles in a polymer, the argyrodite-containing particles having an amorphous outer shell; and thermally annealing the film to crystallize the outer shell. In some embodiments, annealing the film is performed without degrading the polymer. In some embodiments, the polymer is a hydrophobic polymer. In some embodiments, the polymer is not ionically conductive. In some embodiments, the polymer includes one of: styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer includes plastic and elastic segments.

In some embodiments, the method includes prior to providing the film, partially reacting argyrodite precursors by mechanochemical mixing to form particles including argyrodite phase and the unreacted argyrodite precursor compounds. In some embodiments, providing a film including unreacted argyrodite precursor compounds in a polymer includes mixing the particles with the polymer. In some embodiments, the method further includes pressing the film while thermally annealing it. In some embodiments, the film is annealed at a temperature of no more than 550° C. In some embodiments, the film is between 0.5 wt %-60 wt % polymer, 1 wt %-40 wt % polymer, or 5 wt %-30 wt % polymer. In some embodiments, heating the film is performed without thermally degrading the polymer.

Another aspect of the disclosure relates to a method including: providing a composition including argyrodite, polymer, and a first solvent suitable for liquid phase sintering; heating the argyrodite at a temperature of no more than 300° C. and evaporating the first solvent to form a green composite film; and thermally annealing at a temperature greater than 300° C. the green composite under pressure to form an electrolyte film. In some embodiments, annealing the film is performed without degrading the polymer. In some embodiments, the polymer is a hydrophobic polymer. In some embodiments. the polymer is not ionically conductive.

In some embodiments, the polymer includes one or styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments.

In some embodiments, the method further includes, prior to providing the film, partially reacting argyrodite precursors by mechanochemical mixing to form particles including argyrodite phase and the unreacted argyrodite precursor compounds. In some embodiments, providing a film including unreacted argyrodite precursor compounds in a polymer includes mixing the particles with the polymer. In some embodiments, the method further includes pressing the film while thermally annealing it. In some embodiments, the film is annealed at a temperature of no more than 550° C.

In some embodiments, the film is between 0.5 wt %-60 wt % polymer, 1 wt %-40 wt % polymer, or 5 wt %-30 wt % polymer. In some embodiments, heating the film is performed without thermally degrading the polymer. In some embodiments, the first solvent is selected from: ethanol, tetrahydrofuran, N-methyl pyrrolidone, acetonitrile, or ethyl propionate. In some embodiments, the composition further includes a second solvent.

Another aspect of the disclosure relates to a composition including: a composite film of ionically conductive argyrodite-containing particles in a polymer, the particles having an aspect ratio of less than 0.8 or less than 0.5. In some embodiments, the polymer is a hydrophobic polymer. In some embodiments, the polymer is not ionically conductive.

In some embodiments, the polymer is one of styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments. In some embodiments, the film is between 0.5 wt %-60 wt % polymer, 1 wt %-40 wt % polymer, or 5 wt %-30 wt % polymer.

In some embodiments, the argyrodite has the formula Li₇₋ₓPS₆₋ₓXₓ (X=Cl, Br, I, and 0<x<2). In some such embodiments, x is greater than 1.

Yet another aspect of the disclosure composition includes a composite film of ionically conductive argyrodite-containing particles in a polymer, the composite film oriented in an x-y plane and having a thickness in the z-direction, the particles oriented in the x-y plane of the composite film and characterized by having x-y dimensions greater than the thickness of the film and a z-dimension less than or equal to the thickness of the film. In some embodiments, the polymer is a hydrophobic polymer. In some embodiments, the polymer is not ionically conductive.

In some embodiments, the polymer is styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments.

In some embodiments, the film is between 0.5 wt %-60 wt % polymer, 1 wt %-40 wt % polymer, or 5 wt %-30 wt % polymer. In some embodiments, the argyrodite has the formula Li₇₋ₓPS₆₋ₓXₓ (X=Cl, Br, I, and 0<x<2). In some such embodiments, x is greater than 1.

Another aspect of the disclosure relates to a composition including a composite film of ionically conductive argyrodite-containing particles in a polymer. In some embodiments, the polymer is a hydrophobic polymer. In some embodiments, the polymer is not ionically conductive. In some embodiments, the polymer is one of styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments. In some embodiments, the film is between 0.5 wt %-60 wt % polymer, 1 wt %-40 wt % polymer, or 5 wt %-30 wt % polymer. In some embodiments, the argyrodite has the formula Li₇₋ₓPS₆₋ₓXₓ (X=Cl, Br, I, and 0<x<2). In some such embodiments, x is greater than 1.

Another aspect of the disclosure relates to a composition including: a slurry, paste, or solution including one or more solvents, a polymer, and ionically conductive argyrodite-containing particles. In some embodiments, the polymer is a hydrophobic polymer. In some embodiments, the polymer is not ionically conductive.

In some embodiments, the polymer includes one of styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR).

In some embodiments, the polymer is a copolymer that includes plastic and elastic segments. In some embodiments, the argyrodite has the formula Li₇₋ₓPS₆₋ₓXₓ (X=Cl, Br, I, and 0<x<2). In some such embodiments, x is greater than 1.

Another aspect of the disclosure relates to a composition including a composite film including unreacted argyrodite precursor compounds in a polymer. In some embodiments, the argyrodite precursor compounds include Li₂S and LiX wherein X is a halide. In some embodiments, the film including unreacted argyrodite precursor compounds in a polymer has substantially no argyrodite phase. In some embodiments, the film including unreacted argyrodite precursor compounds in a polymer includes argyrodite. In some such embodiments, the weight ratio of the unreacted argyrodite precursor compounds to argyrodite is at least 0.2:1, 0.5:1, 1:1, 1.5:1, or 2:1. In some embodiments, the film is between 0.5 wt %-60 wt % polymer, 1 wt %-40 wt % polymer, or 5 wt %-30 wt % polymer. In some embodiments, the polymer is a hydrophobic polymer.

In some embodiments, the polymer is not ionically conductive. In some embodiments, the polymer includes styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments.

Another aspect of the disclosure relates a composition including a slurry, paste, or solution including one or more solvents, unreacted argyrodite precursor compounds, and a polymer. In some embodiments, the argyrodite precursor compounds include Li₂S and LiX wherein X is a halide. In some embodiments, the slurry, paste, or solution including unreacted argyrodite precursor compounds has substantially no argyrodite phase. In some embodiments, the slurry, paste, or solution including unreacted argyrodite precursor compounds includes argyrodite. In some embodiments, the weight ratio of the unreacted argyrodite precursor compounds to argyrodite is at least 0.2:1, 0.5:1, 1:1, 1.5:1, or 2:1. In some embodiments, the polymer is a hydrophobic polymer. In some embodiments, the polymer is not ionically conductive.

In some embodiments, the polymer is one of styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, the polymer is a copolymer including plastic and elastic segments.

Another aspect of the disclosure relates to a composition including a transition metal oxide active material, argyrodite, and an organic polymer. In some embodiments, the polymer is a hydrophobic polymer. In some embodiments, the polymer is not ionically conductive. In some embodiments, the polymer is one of styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR).

In some embodiments, the composition further includes a conductive additive. In some embodiments, the active material is between 65% and 88% by weight of the composition. In some embodiments, the argyrodite is between 10% and 33% by weight of the composition. In some embodiments, the organic polymer is between 1% and 5% by weight of the composition. In some embodiments, the conductive additive is between 1% and 5% by weight of the composition. In some embodiments, the composition is part of a battery. In some such embodiments, a mesh current collector is embedded in the composition.

Another aspect of the disclosure relates to a composition including: an active material selected from one or both of a silicon-containing active material and a graphitic active material, argyrodite, and an organic polymer. In some embodiments the polymer is a hydrophobic polymer. In some embodiments, the polymer is not ionically conductive. In some embodiments, the polymer is styrene ethylene butylene styrene (SEBS), styrene-butadiene-styrene (SBS), styrene-isoprene-styrene (SIS), styrene-isoprene/butadiene-styrene (SIBS), styrene-ethylene/propylene (SEP), styrene-ethylene/propylene-styrene (SEPS), and isoprene rubber (IR). In some embodiments, silicon is between 15% and 50% by weight of the composition. In some embodiments, the graphitic active material is between 5% and 40% by weight of the composition. In some embodiments, argyrodite is between 10% and 50% by weight of the composition.

In some embodiments, the organic polymer is between 1% and 5% by weight of the composition. In some embodiments, the composition further includes a conductive additive that is no more than 5% by weight of the composition. In some embodiments, the composition is part of a battery. In some such embodiments, a mesh current collector is embedded in the composition.

Another aspect of the disclosure relates to a composite including inorganic ionically conductive argyrodite-containing particles; and an organic phase including a polymer binder. In some embodiments, the polymer binder is polar. In some embodiments, the polymer binder is poly(vinylacetate) or nitrile butadiene rubber having up to 30% nitrile groups. In some embodiments, the polymer binder is poly(acrylonitrile-co-styrene-co-butadiene) (ABS), poly(ethylene-co-vinylacetate), poly(styrene-co-acrylonitrile) (SAN), poly(styrene-co-maleic anhydride), poly(meth)acrylates, poly(alkyene glycols), poly(butadiene-co-acrylate), poly(butadiene-co-acrylic acid-co-acrylonitrile), poly(ethylene-co-acrylates), polyethers, polyesters of dialkyl phthalates, or poly(vinyl chloride) (PVC).

In some embodiments, the polymer binder is insoluble in solvents having polarity indexes below 3.5. In some embodiments, the organic phase is at least 50 wt. %, at least 90% wt. or at least 99% wt. % binder.

Another aspect of the disclosure relates a method including: providing a stack including one or more battery electrode films and a composite separator film, wherein the composite separator film includes argyrodite particles dispersed in a polymer film; and heating the stack under pressure to fuse argyrodite particles in the polymer film.

In some embodiments, the stack includes the composite separator film sandwiched between an anode film and a cathode film. In some embodiments, heating the stack under pressure includes calendaring the composite separator film with one or both of an anode film and a cathode film. In some embodiments, the method further includes calendaring the composite separator film with at least one of the one or more battery electrode films prior to heating the stack under pressure.

In some embodiments, heating the stack under pressure includes heating it to a temperature of between 80° C. to 160° C.

In some embodiments, the pressure is at least 10 MPa. In some embodiments, heating the stack under pressure includes heating it to a temperature greater than a glass transition temperature or melting temperature of the polymer. In some embodiments, the polymer is a styrenic block copolymer. In some embodiments, the styrenic block copolymer is one of styrene-ethylene/butylene-styrene (SEBS), styrene-butadiene-styrene (SBS), and styrene-isoprene-styrene (SIS).

These and other aspects of the disclosure are discussed below with respect to the Figures.

### BRIEF DESCRIPTION OF THE DRAWINGS

FIG. 1 shows the crystal structure of an example argyrodite, Li₆PS₅Cl.

FIG. 2 illustrates a simplified mechanism of morphological changes occurring during annealing of argyrodite prepared via ball-milling.

FIGS. 3 and 4 are a process flow diagram that illustrates certain operations in methods of fabricating composite electrolytes provided herein.

FIG. 5 is a process diagram showing operations in a method of forming a composite including liquid phase-assisted sintering according to various embodiments.

FIGS. 6A-6C show schematic examples of cells according to various embodiments.

FIG. 7 shows a schematic example of an electrode having an embedded current collector.

FIG. 8 shows conductivity dependence of argyrodite-containing electrolyte composites on heat press temperature.

FIG. 9 shows overlay x-ray diffraction (XRD) spectra of composites (solid lines) including ball milled argyrodite compared with starting partially unreacted argyrodite.

FIG. 10 shows XRD spectra of ball-milled Li₆PS₅Cl argyrodite powder and a composite including the powder.

FIG. 11 shows XRD spectra of annealed argyrodite and a composite including the annealed argyrodite.

FIG. 12 shows conductivities of thermally-processed ball-milled and annealed composites.

FIG. 13 shows top-down SEM image of ball-milled argyrodite-containing composites processed at different temperatures.

FIG. 14 shows top-down SEM image of ball-milled argyrodite-containing composites processed at different temperatures.

FIG. 15 shows XRD spectra of argyrodite powders annealed at different temperature compared to as ball-milled argyrodite.

FIG. 16 summarizes conductivity data collected for argyrodite-containing composites thermally processed at 180° C. (diamond), 210° C. (triangle), and 250° C. (circle), and plotted against annealing temperature of the corresponding argyrodite. Conductivities for the corresponding argyrodites is also shown.

FIG. 17 shows a stress-strain profile of an argyrodite-containing composite (argyrodite annealed at 250° C. and composite processed at 210° C.).

FIG. 18 shows conductivity and elongation at break of argyrodite-containing composites vs. annealing temperature of the argyrodite powder.

FIG. 19 shows conductivity and Young's Modulus of argyrodite-containing composites vs. annealing temperature of the argyrodite powder.

FIG. 20 shows conductivity and mechanical strength of argyrodite-containing composites vs. annealing temperature of the argyrodite powder.

FIG. 21 shows SEM images of as-cast and in situ processed argyrodite containing composites (top row), with corresponding image analysis results in the row below.

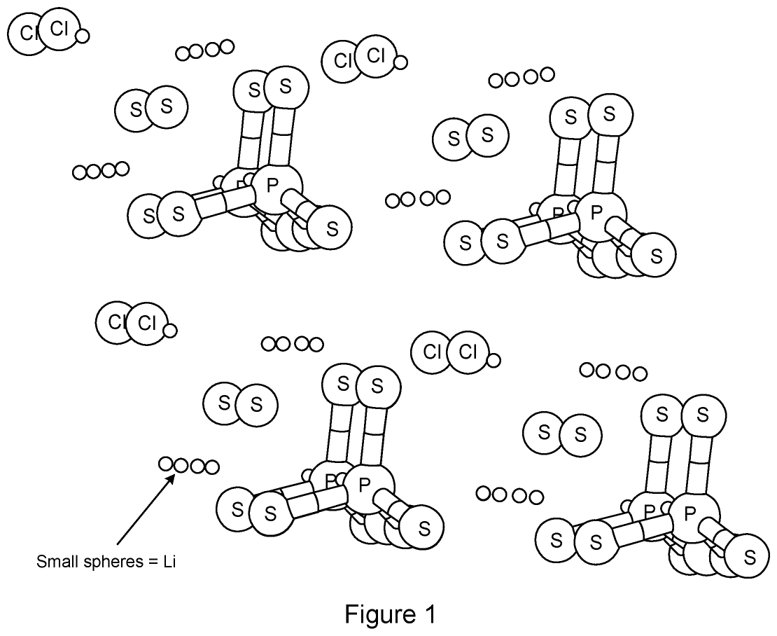

### DETAILED DESCRIPTION

Provided herein are composite materials that include an ionically conductive inorganic solid particulate phase and an organic polymer phase. The ionically conductive inorganic solid particular phase includes an alklai metal argyrodite. Particular embodiments of the subject matter described herein may have the following advantages. In some embodiments, the ionically conductive solid-state compositions may be processed to a variety of shapes with easily scaled-up manufacturing techniques. The manufactured composites are compliant, allowing good adhesion to other components of a battery or other device. The solid-state compositions have high ionic conductivity, allowing the compositions to be used as electrolytes or electrode materials. In some embodiments, ionically conductive solid-state compositions enable the use of lithium metal anodes by resisting dendrites. The composite electrolytes described here are solid and do not contain chemicals that are incompatible with each other at high temperatures. Further details of the ionically conductive solid-state compositions, solid-state electrolytes, separators, electrodes, and batteries according to embodiments of the present invention are described below.

The ionically conductive solid-state compositions may be referred to as hybrid compositions herein. The term “hybrid” is used herein to describe a composite material including an inorganic phase and an organic phase. The term “composite” is used herein to describe a composite of an inorganic material and an organic material.

The term “number average molecular weight” or “Mn” in reference to a particular component (e.g., a first component or high molecular weight polymer binder) of a solid-state composition refers to the statistical average molecular weight of all molecules of the component expressed in units of g/mol. The number average molecular weight may be determined by techniques known in the art such as, for example, gel permeation chromatography (wherein Mn can be calculated based on known standards based on an online detection system such as a refractive index, ultraviolet, or other detector), viscometry, mass spectrometry, or colligative methods (e.g., vapor pressure osmometry, end-group determination, or proton NMR). The number average molecular weight is defined by the equation below,

$${M}_{n} = \frac{Σ {N}_{i} {M}_{i}}{Σ {N}_{i}}$$

wherein Mᵢ is the molecular weight of a molecule and Ni is the number of molecules of that molecular weight.

The term “weight average molecular weight” or “M_{w}” in reference to a particular component (e.g., a first component or high molecular weight polymer binder) of a solid-state composition refers to the statistical average molecular weight of all molecules of the component taking into account the weight of each molecule in determining its contribution to the molecular weight average, expressed in units of g/mol. The higher the molecular weight of a given molecule, the more that molecule will contribute to the M_{w} value. The weight average molecular weight may be calculated by techniques known in the art which are sensitive to molecular size such as, for example, static light scattering, small angle neutron scattering, X-ray scattering, and sedimentation velocity. The weight average molecular weight is defined by the equation below,

$${M}_{w} = \frac{Σ {N}_{i} {M}_{i}^{2}}{Σ {N}_{i} {M}_{i}}$$

wherein ‘Mᵢ’ is the molecular weight of a molecule and ‘Nᵢ’ is the number of molecules of that molecular weight. In the description below, references to molecular weights of particular polymers refer to number average molecular weight.

### Inorganic Ion Conductors

The mineral Argyrodite, Ag₈GeS₆, can be thought of as a co-crystal of Ag₄GeS₄ and two equivalents of Ag₂S. Substitutions in both cations and anions can be made in this crystal while still retaining the same overall spatial arrangement of the various ions. In Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original Ag₈GeS₆, some cation sites are vacant. These structural analogs of the original Argyrodite mineral are referred to as argyrodites as well.

Both Ag₈GeS₆ and Li₇PS₆ are orthorhombic crystals at room temperature, while at elevated temperatures phase transitions to cubic space groups occur. Making the further substitution of one equivalent of LiCl for one Li₂S yields the material Li₆PS₅Cl, which still retains the argyrodite structure but undergoes the orthorhombic to cubic phase transition below room temperature and has a significantly higher lithium-ion conductivity. Because the overall arrangement of cations and anions remains the same in this material as well, it is also commonly referred to as an argyrodite. Further substitutions which also retain this overall structure may therefore also be referred to as argyrodites. Alkali metal argyrodites more generally are any of the class of conductive crystals with alkali metals occupying Ag+ sites in the original Argyrodite structure, and which retain the spatial arrangement of the anions found in the original mineral. In one example, a lithium-containing example of this mineral type, Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original Ag₈GeS₆, some cation sites are vacant. Making the further substitution of one equivalent of LiCl for one Li₂S yields the material Li₆PS₅Cl, which still retains the argyrodite structure. There are various manners in which substitutions may be made that retain the overall argyrodite structure. For example, the original mineral has two equivalents of S²⁻, which can be substituted with chalcogen ions such as O²⁻, Se²⁻, and Te²⁻. A significant fraction of the of S²⁻ can be substituted with halogens. For example, up to about 1.6 of the two equivalents of S²⁻ can be substituted with Cl⁻, Br⁻, and I⁻¹, with the exact amount depending on other ions in the system. While Cl⁻is similar in size to S²⁻, it has one charge instead of two and has fairly different bonding and reactivity properties. Other substitutions may be made, for example, in some cases, some of the S²⁻ can be substituted with a halogen (e.g., CO and the rest replaced with Se²⁻. Similarly, various substitutions may be made for the GeS₄³⁻ sites. PS₄³⁻ may replace GeS₄³⁻; also PO₄³⁻, PSe₄³⁻, SiS₄³⁻, etc. These are all tetrahedral ions with four chalcogen atoms, overall larger than S²⁻, and triply or quadruply charged.

In some embodiments, the argyrodites may have the formula:

A₇₋ₓPS₆₋ₓHalₓ

A is an alkali metal and Hal is selected from chlorine (CI), bromine (Br), and iodine (I) and 0≤x≤2. In some embodiments, 0<x≤2, or 0<x<2. Hal may also be referred to herein and “X”.

In some embodiments, the argyrodite may have a general formula as given above, and further be doped. An example is argyrodites doped with thiophilic metals:

A_{7-x-(z*m)}M^{z}ₘPS₆₋ₓHalₓ

wherein A is an alkali metal; M is a metal selected from manganese (Mn), iron (Fe), cobalt (Co), nickel (Ni), copper (Cu), zinc (Zn), and mercury (Hg); Hal is selected from chlorine (CI), bromine (Br), and iodine (I); z is the oxidation state of the metal; 0≤x≤2; and 0≤m<(7−x)/z. In some embodiments, A is lithium (Li), sodium (Na) or potassium (K). In some embodiments, A is Li. Metal-doped argyrodites are described further in U.S. Provisional Patent Application No. 62/888,323, incorporated by reference herein. In some embodiments, the composite may include oxide argyrodites, for example, as described in U.S. patent application Ser. No. 16/576,570, incorporated by reference herein.

Alkali metal argyrodites more generally are any of the class of argyrodite-like conductive crystals of with cubic symmetry that include an alkali metal. This includes argyrodites of the formulae given above as well as argyrodites described in US Patent Publication No. 20170352916 which include Li_{7-x+y}PS₆₋ₓCl_{x+y} where x and y satisfy the formula 0.05≤y≤0.9 and −3.0x+1.8≤y≤−3.0x+5, or other argyrodites with A_{7-x+y}PS₆₋ₓHal_{x+y} formula. Such argyrodites may also be doped with metal as described above, which include A_{7-x+y-(z*m)}M^{z}ₘPS₆₋ₓHal_{x+y}.

The conductivity of argyrodites is controlled by different factors, including:

1) Chemical composition
2) Synthetic approach—e.g., high energy ball-milling, solid-state synthesis; and
3) Thermal processing, which can affect

a) 4a and 4c sites occupation

b) Fraction of crystal phase; and

c) Crystallite size

Composition and thermal treatment directly affect the mechanical properties of argyrodites as well. Amorphous materials are much easier to process, but are typically less conductive and weaker than crystals. Crystalline materials are more difficult to process but have higher conductivity and better mechanical properties.

Lithium argyrodite conductors are considered crystalline materials with high conductivities resulting from their cubic-centered sublattice structure. In reality, argyrodites are much more complex materials with their structure-property relationship dependent on the composition, synthetic technique, processing and microstructure. When ionic transport is considered, the crystal structure can be influenced by amorphous phase. Even in very crystalline materials, so-called secondary amorphous phases may exist. These phases might not have distinct scattering domains, but at the same time they are not entirely amorphous and can significantly influence the ionic conductivity. Depending on the conductive nature of the crystalline materials, such amorphous phases can improve or hinder ionic transport. For poor conductors, secondary glass phases can act as conductive fillers, whereas in highly conductive crystals they can restrict the movement of ions.

Synthetic conditions and processing may be adjusted to attain an appropriate ratio of amorphous to crystalline phases for good transport behavior. Synthetic conditions also affect not only crystallinity of the material, but also its crystal structures. Mechanical alloying and high temperature solid-state syntheses are two possible synthetic routes. Mechanochemical synthesis may be done by high energy ball-milling and reduces crystallinity and forms highly amorphous materials. A ball-milling approach can also stabilize, often very conductive, metastable phases, which cannot be obtained in traditional high temperature approaches that lean towards thermodynamically stable species. The synthetic approach can also affect the global structure of a crystal, changing its average but not the local structure; effectively largely changing its ionic transport behavior.

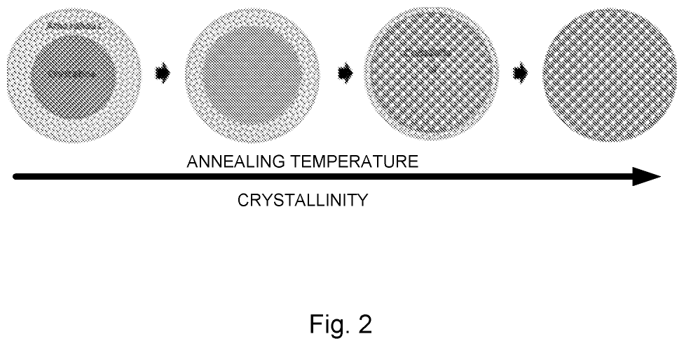

FIG. 2 illustrates a simplified mechanism of morphological changes occurring during annealing of argyrodite prepared via ball-milling. Argyrodite prepared via mechanochemical approach is still highly amorphous, with the glassy phase coating the crystalline core made of small (e.g., 20 nm) crystallites. During annealing, several competing processes occur that affect the final properties of argyrodite powder, primarily crystallization of the amorphous phase and growth of crystallites. Crystallization of the amorphous phase leads to improved conductivity and largely influences process-ability and grain boundaries. Growth of crystallites also affects conductivity but needs to be controlled to enable proper material transport and good sintering between crystallites without causing thermal degradation.

According to various embodiments, the inorganic conductors have an ionic conductivity of at least 1e⁻³ S/cm and in some embodiments at least 1e⁻³ S/cm. Processing of argyrodites for composites that have high conductivity and good mechanical properties is described further below.

### Organic Polymer Phase

The organic polymer phase may include one or more polymers and is chemically compatible with the inorganic ion conductive particles. In some embodiments, the organic phase has substantially no ionic conductivity, and is referred to as “non-ionically conductive.” Non-ionically conductive polymers are described herein have ionic conductivities of less than 0.0001 S/cm.

In some embodiments, the organic phase includes a polymer binder, a relatively high molecular weight polymer or mixture of different high molecular weight polymers. A polymer binder has a molecular weight of at least 30 kg/mol, and may be at least 50 kg/mol, or 100 kg/mol. The molecular weight distribution can be monomodal, bimodal and multimodal.

In some embodiments, the polymer binder has a non-polar backbone. Examples of non-polar polymer binders include polymers or copolymers including styrene, butadiene, isoprene, ethylene, and butylene. Styrenic block copolymers including polystyrene blocks and rubber blocks may be used, with examples of rubber blocks including polybutadiene (PBD) and polyisoprene (PI). The rubber blocks may or may be hydrogenated. Specific examples of polymer binders are styrene ethylene butylene styrene (SEBS), styrene-butadiene-styrene (SBS), styrene-isoprene-styrene (SIS), styrene-butadiene rubber (SBR), polystyrene (PSt), PBD, polyethylene (PE), and PI. Non-polar polymers do not coat the inorganic particles, which can lead to reduced conductivity.

Smaller molecular weight polymers may be used to improve the processability of larger molecular weight polymers such as SEBS, reducing processing temperatures and pressures, for example. These can have molecular weights of 50 g/mol to 30 kg/mol, for example. Examples include polydimethylsiloxane (PDMS), polybutadiene (PBD), and polystyrene. In some embodiments, the first component is a cyclic olefin polymer (COP)., the first component is a polyalkyl, polyaromatic, or polysiloxane polymer having end groups selected from cyano, thiol, amide, amino, sulfonic acid, epoxy, carboxyl, or hydroxyl groups.

The main chain or backbone of the polymeric components of the organic phase do not interact strongly with the inorganic phase. Examples of backbones include saturated or unsaturated polyalkyls, polyaromatics, and polysiloxanes. Examples of backbones that may interact too strongly with the inorganic phase include those with strong electron donating groups such as polyalcohols, polyacids, polyesters, polyethers, polyamines, and polyamides. It is understood that molecules that have other moieties that decrease the binding strength of oxygen or other nucleophile groups may be used. For example, the perfluorinated character of a perfluorinated polyether (PFPE) backbone delocalizes the electron density of the ether oxygens and allows them to be used in certain embodiments.

In some embodiments, hydrophobic block copolymers having both plastic and elastic copolymer segments are used. Examples include styrenic block copolymers such as SEBS, SBS, SIS, styrene-isoprene/butadiene-styrene (SIBS), styrene-ethylene/propylene (SEP), styrene-ethylene/propylene-styrene (SEPS), and isoprene rubber (IR).

In some embodiments, the organic phase is substantially non-ionically conductive, with examples of non-ionically conductive polymers including PDMS, PBD, and the other polymers described above. Unlike ionically conductive polymers such as polyethylene oxide (PEO), polypropylene oxide (PPO), polyacrylonitrile (PAN), poly(methyl methacrylate) (PMMA), which are ionically conductive because they dissolve or dissociate salts such as LiI, non-ionically conductive polymers are not ionically conductive even in the presence of a salt. This is because without dissolving a salt, there are no mobile ions to conduct. In some embodiments, one of these or another ionically conductive polymer may be used. PFPE's, referred to above, and described in Compliant glass-polymer hybrid single ion-conducting electrolytes for lithium ion batteries, PNAS, 52-57, vol. 113, no. 1 (2016), incorporated by reference herein, are ionically conductive, being single ion-conductors for lithium and may be used in some embodiments.

In some embodiments, the organic phase may included cross-linking. In some embodiments, the organic phase is a cross-linked polymer network. Cross-linked polymer networks can be cross-linked in-situ, i.e., after the inorganic particles are mixed with polymer or polymer precursors to form a composite. In-situ polymerization, including in-situ cross-linking, of polymers is described in U.S. Pat. No. 10,079,404, incorporated by reference herein.

Polar polymeric binders that are used in other battery applications, such as carboxymethyl cellulose (CMC), polyethylene oxide (PEO), and polyvinylidene fluoride (PVDF), lead to composites having poor ionic coS/nductivity if mixed with inorganic conductors. This is because the polymers can bind strongly to surface of inorganic particles, forming a dense, insulating coating that prevents direct contact with neighboring particles. Even as low as 1-5 wt. % of such polymers can insulate particles and block lithium-ion pathways across the composite, leading to very resistive materials.

In some embodiments, the polymer binder is a thermoplastic elastomer such as SEBS, SBS, or SIS. The non-polarity and hydrophobic character of such binders allow for high retention of initial conductivity of pure inorganic conductors. In composite materials, including electrolyte separators and electrodes, a solvent and/or and polymer can induce either chemical or morphological changes, and/or loss of conductivity in inorganic conductors. For example, sulfidic inorganic conductors including argyrodite-like inorganics can be degraded by polar polymers and/or polar polymers.

Another challenge addressed by the disclosure herein is the instability of sulfidic materials in composite electrolytes in moderately polar and very polar solvents. Table 1, below, shows the effect of solvent polarity on the stability of sulfidic materials.

TABLE 1
Effect of solvent polarity on the stability of sulfidic materials

| Stability of Sulfidic | Polarity Index of | |
|---|---|---|
| Materials | Solvent (P) | Example of Solvent (P) |
| Very Unstable | >4.5 | NMP (6.7) |
| | | Acetonitrile (5.8) |
| | | Acetone (5.1) |
| | | Methyl Ethyl Ketone (4.7) |
| Unstable* | >3.5-4.5 | Ethyl Acetate (4.4) |
| | | THF (4.0) |
| | | Chloroform (4.1) |
| | | n-Butyl Alcohol (3.9) |
| Stable | 0-3.5 | Dichloromethane (3.1) |
| | | Chlorobenzene (2.7) |
| | | Xylene (2.5) |
| | | Cyclohexane (0.2) |
| | | Pentane (0.0) |

*Sulfidic materials are stable in halogenated solvents in this range including chloroform

While glass materials (such as LPS glasses) are susceptible to polar solvents or polymers induced crystallization, which can cause severe losses in conductivities, crystalline argyrodites have better retention of conductivities. Thus, in some embodiments, argyrodite-containing composites can be prepared with various polymeric binders, including very polar ones, as long as the process is be done without the use of polar solvents that degrade the inorganic. Examples of such binders include poly(vinylacetate), nitrile butadiene rubber having up to 30% nitrile groups, poly(acrylonitrile-co-styrene-co-butadiene) (ABS), poly(ethylene-co-vinylacetate), poly(styrene-co-acrylonitrile) (SAN), poly(styrene-co-maleic anhydride), poly(meth)acrylates, poly(alkyene glycols), poly(butadiene-co-acrylate), poly(butadiene-co-acrylic acid-co-acrylonitrile), poly(ethylene-co-acrylates), polyethers, polyesters of dialkyl phthalates, or poly(vinyl chloride) (PVC).

Any of the non-polar or polar binders described herein may constitute at least 50 wt. %, at least 90 wt. %, or least 99 wt. % of the organic phase according to various embodiments.

### Processing

The solid-state compositions may be prepared by any appropriate method with example procedures described below with reference to the Experimental results. Uniform films can be prepared by solution processing methods. In one example method, all components are mixed together by using laboratory and/or industrial equipment such as sonicators, homogenizers, high-speed mixers, rotary mills, vertical mills, and planetary ball mills. Mixing media can be added to aid homogenization, by improving mixing, breaking up agglomerates and aggregates, thereby eliminating film imperfection such as pin-holes and high surface roughness. The resulting mixture is in a form of uniformly mixed slurry with a viscosity varying based on the hybrid composition and solvent content. The substrate for casting can have different thicknesses and compositions. Examples include aluminum, copper and mylar. The casting of the slurry on a selected substrate can be achieved by different industrial methods. In some embodiments, porosity can be reduced by mechanical densification of films (resulting in, for example, up to about 50% thickness change) by methods such as calendaring between rollers, vertical flat pressing, or isostatic pressing. The pressure involved in densification process forces particles to maintain a close inter-particle contact. External pressure, e.g., on the order of 1 MPa to 600 MPa, or 1 MPa to 100 MPa, is applied. In some embodiments, pressures as exerted by a calendar roll are used. The pressure is sufficient to create particle-to-particle contact, though kept low enough to avoid uncured polymer from squeezing out of the press. Polymerization, which may include cross-linking, may occur under pressure to form the matrix. In some implementations, a thermal-initiated or photo-initiated polymerization technique is used in which application of thermal energy or ultraviolet light is used to initiate polymerization. The ionically conductive inorganic particles are trapped in the matrix and stay in close contact on release of external pressure. The composite prepared by the above methods may be, for example, pellets or thin films and is incorporated to an actual solid-state lithium battery by well-established methods.

In some embodiments, the films are dry-processed rather than processed in solution. For example, the films may be extruded. Extrusion or other dry processing may be alternatives to solution processing especially at higher loadings of the organic phase (e.g., in embodiments in which the organic phase is at least 30 wt %).

In embodiments in which solution processing is used, a solvent that does not render the argyrodite unstable is used.

### Inorganic Phase Synthesis

Argyrodites may be synthesized using one of three main synthetic methods: high energy ball-milling (mechanochemical synthesis), solid-state synthesis, and solution synthesis. According to various embodiments, argyrodite synthesis may be done wholly or partially ex-situ prior to incorporation into the composite, or wholly or partially in-situ during or after incorporation into the composite.

High energy ball-milling applies mechanical energy to induce a chemical reaction between argyrodite precursors and forms a highly amorphous particle. An additional annealing step can be used to increase crystallinity, and thus conductivity, of the highly amorphous ball-milled argyrodite. As discussed further below, ball-milled argyrodite can be used incorporated into a composite fully or partially reacted, as well as before or after annealing.

In solid-state synthesis, argyrodite reagents are pre-mixed together and thermally reacted to form argyrodite phase. Unlike ball-milling, solid-state reactions are run at high temperatures that are similar to annealing temperatures, thus providing highly crystalline materials. The reaction might be performed directly in a presence of polymers, but high temperature might lead to the polymer degradation and lower temperatures might not be sufficient to fully react starting materials. The solid-state synthesis can also be pushed to full completion or stopped on any level of conversion to form a mixture of argyrodite and precursors. The reaction can be controlled by tuning synthesis times and temperatures, and such argyrodite can be mixed directly with polymers to form composites.

In argyrodite solution synthesis, reactants are mixed in an argyrodite solvent that enables full or partial dissolution or reagents and/or the products. The approach uses a multi-step solvent removal to obtain pure argyrodite. First, bulk solvent is removed at lower temperatures, typically below 100° C., leading to a mixture or argyrodite and argyrodite precursors, that include starting materials and complex intermediate compounds. Such argyrodite mixture can be incorporated into a composite, and residual solvent bound to argyrodite phase can serve as a sintering aid during thermal processing. During heat treatment residual solvent evaporates transforming precursors into argyrodite phase, while at the same time it helps to sinter inorganic particles via liquid phase sintering. Liquid phase sintering helps reduce pressure and temperature requirements for sintering, while at the same time leading to lower porosity and better densification. The second removal step of the argyrodite-bound solvent can be done prior to incorporation to a composite, obtaining argyrodite with the crystallinity and crystallite size dependent on the processing temperature and time. Such argyrodite can be incorporated into composite.

### In Situ Processing of Inorganic Phase

Crystalline materials use high temperatures for two competing processes, annealing and sintering, to occur. During annealing, the percent of crystallinity increases and the crystallites grow, both of which improve conductivity. Sintering helps with removing grain boundaries, thus improving the inter-particle contact and forming an inorganic network that strengthens the composite.

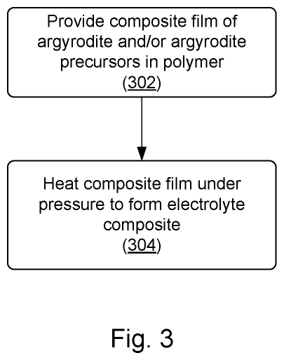

Provided herein are methods of thermal processing of composites. The methods use thermal processing induce phase transitions within inorganic conductor particles after their incorporation into composites without degrading components of the organic phase. FIG. 3 is a process flow diagram that illustrates certain operations in methods of fabricating composite electrolytes provided herein.

First, in an operation 302, a composite film of argyrodite and/or argyrodite precursors in a polymer is provided. Unlike methods in which an inorganic is provided in an organic material for the purpose of sintering, the polymer in operation 302 is the polymer that will be in the eventual composite material (or a precursor thereof). Such polymers are described herein. As indicated, the inorganic phase may include argyrodite and/or precursors thereof. In some embodiments, the inorganic phase at 302 includes no argyrodite and only argyrodite precursors (e.g., LiCl, Li₂S, and P₂S₅ or LiCl and Li₃PS₄ to make Li₆PS₅Cl). In some embodiments, the inorganic phase at 302 includes argyrodite and argyrodite precursors (e.g., Li₆PS₅Cl, LiCl, Li₂S, and P₂S₅). And in some embodiments, the inorganic phase at 302 includes argyrodite with substantially no unreacted precursors. At 304, the composite film is heated under pressure to form a composite film including an argyrodite.

Example pressures include pressures on order of 1 MPa to 600 MPa, or 1 MPa to 100 MPa. During operation N04, one or more of the following occurs: the argyrodite reaction is driven to completion, the argyrodite is wholly or partially crystallized, argyrodite particles are sintered to form sintered particles. Temperatures are low enough to prevent thermal degradation of the polymer phase. As indicated above, this is distinct from sintering operations performed at high temperature in which particles in a polymer are sintered with the polymer burned off. In such operations, polymer may be backfilled to form a composite.

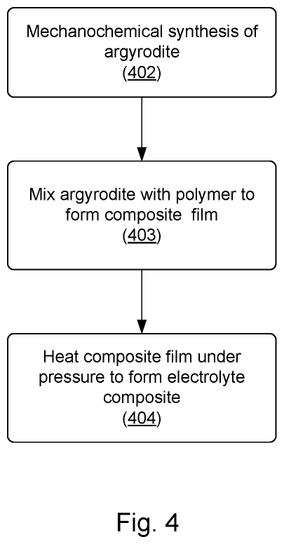

FIG. 4 is a process flow diagram that illustrates certain operations in methods of fabricating composite electrolytes provided herein. The method in FIG. 4 is an example of a method according to FIG. 3. In the method of FIG. 4, at operation 402, mechanochemical synthesis of argyrodite is performed. As discussed above, this may involve high energy ball-milling of argyrodite precursors. According to various embodiments, the reaction may be allowed to go to completion or the ball-milling may be be stopped with some argyrodite precursors purposefully left unreacted.

The argyrodite is mixed with polymer to form a composite film in an operation 403. In some embodiments, the argyrodite is then annealed ex-situ and then mixed with polymer to form a composite film. Annealing may do one or more of driving unreacted precursors to reaction, initiating crystallization, and growing crystallites, which in turn can include fusing if the crystallites are grown across particles. In some embodiments, the argyrodite (and unreacted precursors, if present) are mixed with polymer to form a composite film without annealing.

At 404, the composite film is heated under pressure as described above with respect to operation 304 of FIG. 3. According to various embodiments, operations 304 and 404 may include sintering in which crystallites are grown and can include fusing of discrete particles. During sintering a particle compact body (green body) is transformed into polycrystalline, monolithic body.

The fused particles may be characterized by having necks or narrowed regions in which multiple particles are fused together. For example, particles as ball milled may be nominally circular; as they particles are sintered, they fuse together to form larger, less circular particles. The sintered together particles form a particle network in the composite, with a particular composite including multiple particle networks. The fused particles may be characterized by having dimensions in the plane of the film (x-y plane) much larger than in the z-direction. For example, the aspect ratio of the particles (z:x or z:y dimensions) may be less than 0.8, 0.5, or 0.1.

Sintering involves bulk diffusion from particle to particle via interparticle necks; temperature is raised to around ½ to ¾ of the melting temperatures of the particles for the process to occur. In case of oxide conductors those temperatures are in range above 1000° C., which can significantly restrict material integration, phase stability, compatibility with other materials, and addi to the processing budget. For argyrodite conductors described herein, processing (annealing) temperatures may at most 500° C.-550° C., which makes them much more processable than oxides. Argyrodite formation occurs at as low as 150° C., and grains start to grow at 300° C.

In some embodiments, operation 404 in FIG. 4 can be performed during after calendaring or other pressing of a separator with an electrode. For example, in some embodiments, after an agyrodite is synthesized and milled, it may be mixed with the polymer and a solvent to form a slurry that is cast on a release film. After drying and removal of the release film, the composite is a free-standing separator that can be calendared with an electrode (e.g., an anode). Example pressures during calendaring may range from 10 MPa to 400 MPa. In some embodiments, the electrode/separator is then calendared with the other electrode (e.g., a cathode) to form an electrode/separator/electrode sandwich. In some embodiments, after either or both of the calendaring operations, operation 404 is performed with the stack is heated while be the stack is pressed. Example pressures range from 10 MPa to 400 MPa. The temperature may be above a glass transition or melting temperature of the polymer in the separator. This allows better particle-to-particle contact and in some embodiments, fusing of particles occurs. Examples of temperatures range from 80° C. to 160° C. In some embodiments, operation 404 is performed during calendaring using a heated calendar roll, and may be performed during one or both of the calendaring operations. In some embodiments, operation 404 is performed during calendaring using a heated calendar roll and while calendering both the anode and cathode to the separator simultaneously.

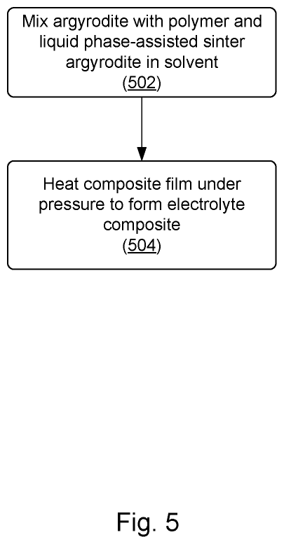

In some embodiments, liquid phase-assisted sintering is performed. Liquid phase-assisted sintering may be performed at low temperatures, e.g., no more than 350° C. or no more than 300° C. Argyrodites are fully soluble in ethanol and partially soluble in solvents such as tetrahydrofuran, N-methyl pyrrolidone, acetonitrile, and ethyl propionate. Solubility in common solvents can be utilized in liquid phase-assisted sintering of those materials to further ease processing. FIG. 5 is a process flow diagram showing operations in a method of forming a composite including liquid phase-assisted sintering. At operation 502, the argyrodite is mixed with polymer and sintered in a solvent.

Prior to or as part of operation 502, the argyrodites can be synthesized ‘in-situ’ via a solvent approach. The polymer can be added during or after the synthesis and the mixture, in a form of a solution or a slurry, can be cast to a form a green composite film. Small amounts of argyrodite solvent (e.g., ethanol, tetrahydrofuran, N-methyl pyrrolidone, acetonitrile, or ethyl propionate) can be added to a composite slurry. The solvent can be incorporated into the composite films in various ways for instance, as a main solvent, co-solvent, slurry additive, solvent-containing inorganic powder, exposure of composite to vapors, soaking, etc. During processing, the solvent enables better lubrication of particles, interparticle transfer of materials via liquid phase, while during evaporation it transforms dissolved argyrodite into solid, while improving a particle-to-particle contact, decreasing porosity, and improving conductivity and mechanical strength of the materials. Liquid phase-assisted sintering can help with reducing processing requirements such as pressure, temperature and (potentially) time. Once sintering is performed, the composite film is heated under pressure in an operation 504 to improve conductivity.

### Composites

The composite materials described herein may take various forms including films and slurries or pastes that may be used to fabricate composite films. According to various embodiments, the composites may include one of the following:

1) argyrodite precursors without argyrodite; and organic polymer;
2) argyrodite precursors, argyrodite, and organic polymer;
3) argyrodite with substantially no precursors; and organic polymer.

In some embodiments, the composites consist essentially of these constituents. In some other embodiments, additional components may be present as described further below. As indicated above, in some embodiments, the composites are provided as a solid film. Depending on the particular composition and the processing to date, the solid films may be provided in a device or ready for incorporation in a device without further processing, or may be provided in ready for in-situ processing of the argyrodite as described above. In the latter case, it may be provided as free-standing film or as incorporated into a device for processing.

The polymer matrix loading in the hybrid compositions may be relatively high in some embodiments, e.g., being at least 2.5%-30% by weight. According to various embodiments, it may between 0.5 wt %-60 wt % polymer, 1 wt %-40 wt % polymer, or 5 wt %-30 wt %. The composites form a continuous film.

The organic polymer is generally a non-polar, or low polar hydrophobic polymer as described above. In certain embodiments, it may be polymer precursors (monomers, oligomers, or polymers) that are also process in situ for polymerization and/or cross-linking. Such processing may occur during in situ processing of the argyrodite or prior to or after it.

In some embodiments, the argyrodite and/or precursors thereof, constitute 40 wt % to 95.5 wt % of the film. The balance may be organic polymer in some embodiments. In other embodiments, one or more additional components are present. Other components can include alkali metal ion salts, including lithium ion salts, sodium ion salts, and potassium ion salts. Examples include LiPF₆, LiTFSI, LiBETI, etc. In some embodiments, the solid-state compositions include substantially no added salts. “Substantially no added salts” means no more than a trace amount of a salt. In some embodiments, if a salt is present, it does not contribute more than 0.05 mS/cm or 0.1 mS/cm to the ionic conductivity. In some embodiments, the solid-state composition may include one or more conductivity enhancers. In some embodiments, the electrolyte may include one or more filler materials, including ceramic fillers such as Al₂O₃. If used, a filler may or may not be an ion conductor depending on the particular embodiment. In some embodiments, the composite may include one or more dispersants. Further, in some embodiments, an organic phase of a solid-state composition may include one or more additional organic components to facilitate manufacture of an electrolyte having mechanical properties desired for a particular application.

In some embodiments, discussed further below, the solid-state compositions are incorporated into, or are ready to be incorporated into, an electrode and include electrochemically active material, and optionally, an electronically conductive additive. Examples of constituents and compositions of electrodes including argyrodites are provided below.

In some embodiments, the electrolyte may include an electrode stabilizing agent that can be used to form a passivation layer on the surface of an electrode. Examples of electrode stabilizing agents are described in U.S. Pat. No. 9,093,722. In some embodiments, the electrolyte may include conductivity enhancers, fillers, or organic components as described above.

In some embodiments, the composites are provided as a slurry or paste. In such cases, the composition includes a solvent to be later evaporated. In addition, the composition may include one or more components for storage stability. Such compounds can include an acrylic resin. Once ready for processing the slurry or paste may be cast or spread on a substrate as appropriate and dried. In situ processing as described above may then be performed.

### Devices

The composites described herein may be incorporated into any device that uses an ionic conductor, including but not limited to batteries and fuel cells. In a lithium battery, for example, the composite may be used as an electrolyte separator.

In some embodiments, the hybrid solid compositions do not include an added salt. Lithium salts (e.g., LiPF₆, LiTFSI), potassium salts, sodium salts, etc., may not be necessary due to the contacts between the ion conductor particles. In some embodiments, the solid compositions consist essentially of ion-conductive inorganic particles and an organic polymer matrix. However, in alternative embodiments, one or more additional components may be added to the hybrid solid composition.

The electrode compositions further include an electrode active material, and optionally, a conductive additive. Example cathode and anode compositions are given below.

For cathode compositions, the table below gives examples of compositions.

| | | | Electronic | |
|---|---|---|---|---|
| | | | conductivity | |
| Constituent | Active material | Argyrodite | additive | Organic phase |
| Examples | Transition Metal | Li₆PS₅Cl | Carbon-based | Hydrophobic block |
| | Oxide | Li_{5.6}PS_{4.6}Cl_{1.4} | Activated | copolymers having soft |
| | Transition Metal | | carbons | and hard blocks |
| | Oxide with layer | | CNTs | SEBS |
| | structure | | Graphene | |
| | NMC | | Graphite | |
| | | | Carbon fibers | |
| | | | Carbon black | |
| | | | (e.g., Super C) | |
| Wt % range | 65%-88% | 10%-33% | 1%-5% | 1%-5% |

According to various embodiments, the cathode active material is a transition metal oxide, with lithium nickel cobalt manganese oxide (LiMnCoMnO₂, or NMC) an example. Various forms of NMC may be used, including LiNi_{0.6}Mn_{0.2}Co_{0.2}O₂ (NMC-622), LiNi_{0.4}Mn_{0.3}Co_{0.3}O₂ (NMC-433). etc. The lower end of the wt % range is set by energy density; compositions having less than 65 wt % active material have low energy density and may not be useful.

Any appropriate argyrodite may be used. Li_{5.6}PS_{4.6}Cl_{1.4} is an example of an argyrodite that has high ionic conductivity and good mechanical properties. Compositions having less than 10 wt % argyrodite have low Li⁺ conductivity.

An electronic conductivity additive is useful for active materials that, like NMC, have low electronic conductivity. Carbon black is an example of one such additive, but other carbon-based additives including other carbon blacks, activated carbons, carbon fibers, graphites, graphenes, and carbon nanotubes (CNTs) may be used. Below 1 wt % may not be enough to improve electronic conductivity while greater than 5% leads to decrease in energy density and disturbing active material-argyrodite contacts.

Any appropriate organic phase may be used. In particular embodiments, hydrophobic block copolymers having both plastic and elastic copolymer segments are used. Examples include styrenic block copolymers such as styrene-ethylene/butylene-styrene (SEBS), styrene-butadiene-styrene (SBS), styrene-isoprene-styrene (SIS), styrene-isoprene/butadiene-styrene (SIBS), styrene-ethylene/propylene (SEP), Styrene-Ethylene/Propylene-Styrene (SEPS), and isoprene rubber (IR). Below 1 wt % may not be enough to achieve desired mechanical properties while greater than 5% leads to decrease in energy density and disturbing active material-argyrodite-carbon contacts.

For anode compositions, the table below gives examples of compositions.

| | | Secondary | | Electronic | |
|---|---|---|---|---|---|
| | Primary active | active | | conductivity | |
| Constituent | material | material | Argyrodite | additive | Organic phase |
| Examples | Si- | Graphite | Li₆PS₅Cl | Carbon-based | Hydrophobic block |
| | containing | | Li_{5.6}PS_{4.6}Cl_{1.4} | Activated | copolymers having |
| | Elemental Si | | | carbons | soft and hard blocks |
| | Si alloys, | | | CNTs | SEBS |
| | e.g., Si | | | Graphene | |
| | alloyed with | | | Carbon fibers | |
| | one or more | | | Carbon black | |
| | of Al, Zn, Fe, | | | (e.g., Super C) | |
| | Mn, Cr, Co, | | | | |
| | Ni, Cu, Ti, | | | | |
| | Mg, Sn, Ge | | | | |
| Wt % range | Si is 15%-50% | 5%-40% | 10%-50% | 0%-5% | 1%-5% |

Graphite is used as a secondary active material to improve initial coulombic efficiency (ICE) of the Si anodes. Si suffers from low ICE (e.g., less than 80% in some cases) which is lower than ICE of NMC and other cathodes causing irreversible capacity loss on the first cycle. Graphite has high ICE (e.g., greater than 90%) enabling full capacity utilization. Hybrid anodes where both Si and graphite are utilized as active materials deliver higher ICE with increasing graphite content meaning that ICE of the anode can match ICE of the cathode by adjusting Si/graphite ratio thus preventing irreversible capacity loss on the first cycle. ICE can vary with processing, allowing for a relatively wide range of graphite content depending on the particular anode and its processing. In addition, graphite improves electronic conductivity and may help densification of the anode.

Any appropriate argyrodite may be used. Li_{5.6}PS_{4.6}Cl_{1.4} is an example of an argyrodite that has high ionic conductivity and good mechanical properties. Compositions having less than 10 wt % argyrodite have low Li⁺ conductivity.

A high-surface-area electronic conductivity additive (e.g., carbon black) may be used some embodiments. Si has low electronic conductivity and such additives can be helpful in addition to graphite (which is a great electronic conductor but has low surface area). However, electronic conductivity of Si alloys can be reasonably high making usage of the additives unnecessary in some embodiments. Other high-surface-area carbons (carbon blacks, activated carbons, graphenes, carbon nanotubes) can also be used instead of Super C.

Any appropriate organic phase may be used. In particular embodiments, hydrophobic block copolymers having both plastic and elastic copolymer segments are used. Examples include styrenic block copolymers such as styrene-ethylene/butylene-styrene (SEBS), styrene-butadiene-styrene (SBS), styrene-isoprene-styrene (SIS), styrene-isoprene/butadiene-styrene (SIBS), styrene-ethylene/propylene (SEP), Styrene-Ethylene/Propylene-Styrene (SEPS), and isoprene rubber (IR). Below 1 wt % may not be enough to achieve desired mechanical properties while greater than 5% leads to decrease in energy density and disturbing active material-argyrodite-carbon contacts.

Provided herein are alkali metal batteries and alkali metal ion batteries that include an anode, a cathode, and a compliant solid electrolyte composition as described above operatively associated with the anode and cathode. The batteries may include a separator for physically separating the anode and cathode; this may be the solid electrolyte composition.

Examples of suitable anodes include but are not limited to anodes formed of lithium metal, lithium alloys, sodium metal, sodium alloys, carbonaceous materials such as graphite, and combinations thereof. Examples of suitable cathodes include, but are not limited to cathodes formed of transition metal oxides, doped transition metal oxides, metal phosphates, metal sulfides, lithium iron phosphate, sulfur and combinations thereof. In some embodiments, the cathode may be a sulfur cathode.

In an alkali metal-air battery such as a lithium-air battery, sodium-air battery, or potassium-air battery, the cathode may be permeable to oxygen (e.g., mesoporous carbon, porous aluminum, etc.), and the cathode may optionally contain a metal catalyst (e.g., manganese, cobalt, ruthenium, platinum, or silver catalysts, or combinations thereof) incorporated therein to enhance the reduction reactions occurring with lithium ion and oxygen at the cathode.

In some embodiments, lithium-sulfur cells are provided, including lithium metal anodes and sulfur-containing cathodes. In some embodiments, the solid-state composite electrolytes described herein uniquely enable both a lithium metal anode, by preventing dendrite formation, and sulfur cathodes, by not dissolving polysulfide intermediates that are formed at the cathode during discharge.

A separator formed from any suitable material permeable to ionic flow can also be included to keep the anode and cathode from directly electrically contacting one another. However, as the electrolyte compositions described herein are solid compositions, they can serve as separators, particularly when they are in the form of a film.

In some embodiments, the solid electrolyte compositions serve as electrolytes between anodes and cathodes in alkali ion batteries that rely on intercalation of the alkali ion during the

As described above, in some embodiments, the solid composite compositions may be incorporated into an electrode of a battery. The electrolyte may be a compliant solid electrolyte as described above or any other appropriate electrolyte, including liquid electrolyte.

In some embodiments, a battery includes an electrode/electrolyte bilayer, with each layer incorporating the ionically conductive solid-state composite materials described herein.

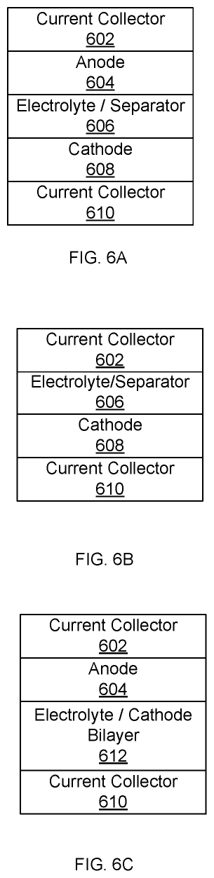

FIG. 6A shows an example of a schematic of a cell according to certain embodiments of the invention. The cell includes a negative current collector 602, an anode 604, an electrolyte/separator 606, a cathode 608, and a positive current collector 610. The negative current collector 602 and the positive current collector 610 may be any appropriate electronically conductive material, such as copper, steel, gold, platinum, aluminum, and nickel. In some embodiments, the negative current collector 602 is copper and the positive current collector 610 is aluminum. The current collectors may be in any appropriate form, such as a sheet, foil, a mesh, or a foam. According to various embodiments, one or more of the anode 604, the cathode 608, and the electrolyte/separator 606 is a solid-state composite including an argyrodite as described above. In some embodiments, two or more of the anode 604, the cathode 608, and the electrolyte 606 is solid-state composite including an argyrodite, as described above.

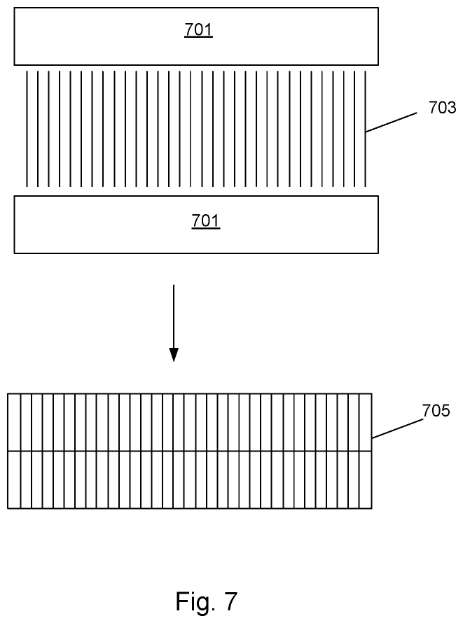

In some embodiments, a current collector is a porous body that can be embedded in the corresponding electrode. For example, it may be a mesh. Electrodes that include hydrophobic polymers as described above may not adhere well to current collectors in the form of foils; however meshes provide good mechanical contact. In some embodiments, two composite films as described herein may be pressed against a mesh current collector to form an embedded current collector in an electrode. A schematic is shown in FIG. 7 with composite films 701 and mesh 703 pressed together to form an electrode 704 having an embedded current collector. The current collector material may be chemically compatible with sulfur; copper and nickel, for example, react in the presence of sulfurous materials and may be avoided. In some embodiments, stainless steel is used. Stainless steel in foil form can be insufficiently ductile, however, a mesh stainless steel current collector avoids this issue.

FIG. 6B shows an example of schematic of a cell as-assembled according to certain embodiments of the invention. The cell as-assembled includes a negative current collector 602, an electrolyte/separator 606, a cathode 608, and a positive current collector 610. Lithium metal is generated on first charge and plates on the negative current collector 602 to form the anode. One or both of the electrolyte 606 and the cathode 608 may be a composite material as described above. In some embodiments, the cathode 608 and the electrolyte 606 together form an electrode/electrolyte bilayer. FIG. 6C shows an example of a schematic of a cell according to certain embodiments of the invention. The cell includes a negative current collector 602, an anode 604, a cathode/electrolyte bilayer 612, and a positive current collector 610. Each layer in a bilayer may include argyrodite. Such a bilayer may be prepared, for example, by preparing an electrolyte slurry and depositing it on an electrode layer.

All components of the battery can be included in or packaged in a suitable rigid or flexible container with external leads or contacts for establishing an electrical connection to the anode and cathode, in accordance with known techniques.

### EXAMPLE EMBODIMENTS

### Example 1: In-Situ Modification of Argyrodite in Composite Electrolytes

Li₆PS₅Cl argyrodite (BM-LPSCI-20) was synthesized via ball-milling for short time (20 hrs), purposely leaving it partially unreacted. XRD spectra of BM-LPSCI-20 confirmed presence of argyrodite phase (diamonds), with large fraction of residual, unreacted Li₂S (stars) and traces of LiCl (circles). The size of crystallites was very small, as shown by a large width of peaks, and together with uneven baseline suggested a substantial amount of amorphous phase present in BM-LPSCI-20. Conductivity of BM-LPSCI-20 was 1.04 mS/cm.

BM-LPSCI-20 was incorporated into a composite film via slurry-casting containing 20 wt. % SEBS. The film was dried overnight under vacuum at room temperature and then pressed at 30 MPa for 12 hrs using a vertical press, while heating three samples at 160, 180, and 210° C. respectively. The resulting BM-20-AC-160, BM-20-AC-180 and BM-20-AC-210 films were analyzed with conductivity measurements, XRD and SEM analyses.

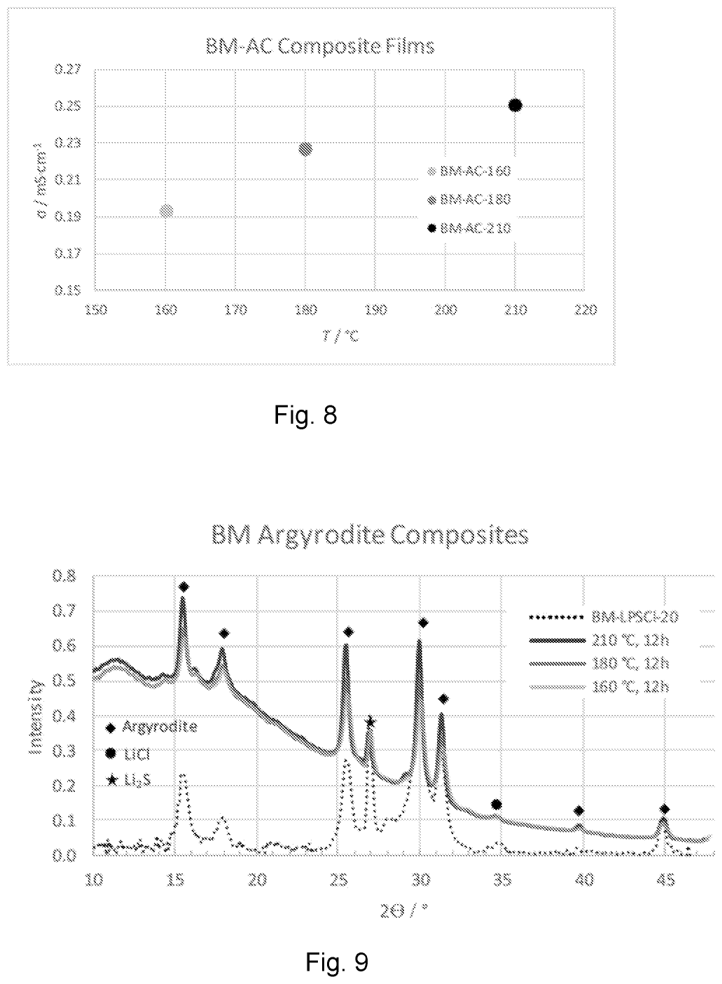

The composite films each had a uniform thickness of about 35 μm, independently of treatment temperature. The conductivity measurements were done with a disc of each composite sandwiched between two blocking electrodes and pressed under 60 MPa. Impedance data showed that conductivity increases with increased heating temperature, varying from 0.19 to 0.25 mS/cm for BM-20-AC-160 and BM-20-AC-210 respectively. See FIG. 8.

X-ray diffraction (XRD) analyses of the BM-20-AC-160, BM-20-AC-180 and BM-20-AC-210 composites confirm in-situ synthesis of the argyrodite and/or sintering occur during the post-processing (heated pressing) of the composites. FIG. 9 shows overlayer XRD spectra of composites (solid lines) compared with starting partially unreacted argyrodite BM-LPSCI. (Note that the slope of the baseline in the composites' spectra is due to the Kapton sheet causing the scattering rather than the signal coming from samples.) As demonstrated in FIG. 9, the relative intensity of argyrodite to Li₂S signals is drastically higher in composites than in the starting argyrodite. This demonstrates that in-situ synthesis and/or sintering of the argyrodite occurs during post-processing and evidences that the increase in conductivity shown in FIG. 8 is not merely due to increased densification and/or interparticle contact.

The width of peaks associated with the associated with argyrodite phase decreased in the composites, which evidences annealing within the crystalline phase that leads to growth of crystallites. Additionally the argyrodite:Li₂S signal progressively increased for the BM-20-AC-160, BM-20-AC-180 and BM-20-AC-210, confirming that the changes in argyrodite phase were more pronounced at higher temperature. This also evidences that sintering and/or argyrodite synthesis occurs as they are more efficient at higher temperatures

SEM imaging of BM-20-AC-160, BM-20-AC-180 and BM-20-AC-210 showed morphological differences between the composites. SEM images of BM-20-AC-160 showed presence of two inorganic phases, crystalline and amorphous ones. The crystal phase appeared dark, as large, dense objects with a distinct nanostructure, whereas the light, amorphous phase formed a thin, cracked coating on their surfaces and was evenly scattered. The polymer phase was not easily distinguishable as it formed a thin coating on inorganic particles. BM-20-AC-180 and BM-20-AC-210 showed similar features to BM-AC-160, however, with a definite temperature effect on the observed morphology. From top-down images it was qualitatively determined that increasing temperature leads to higher fraction of crystalline (dark) phase observed. In addition, the number and size of crystalline objects substantially increased by going from 160 to 210° C. Interestingly, a cross-sectional view of BM-20-AC-210 revealed that crystals with sharp, blade-like shapes were formed when processed at 210° C.

### Example 2: Performance of Composite Electrolytes Including In-Situ Processed Argyrodites

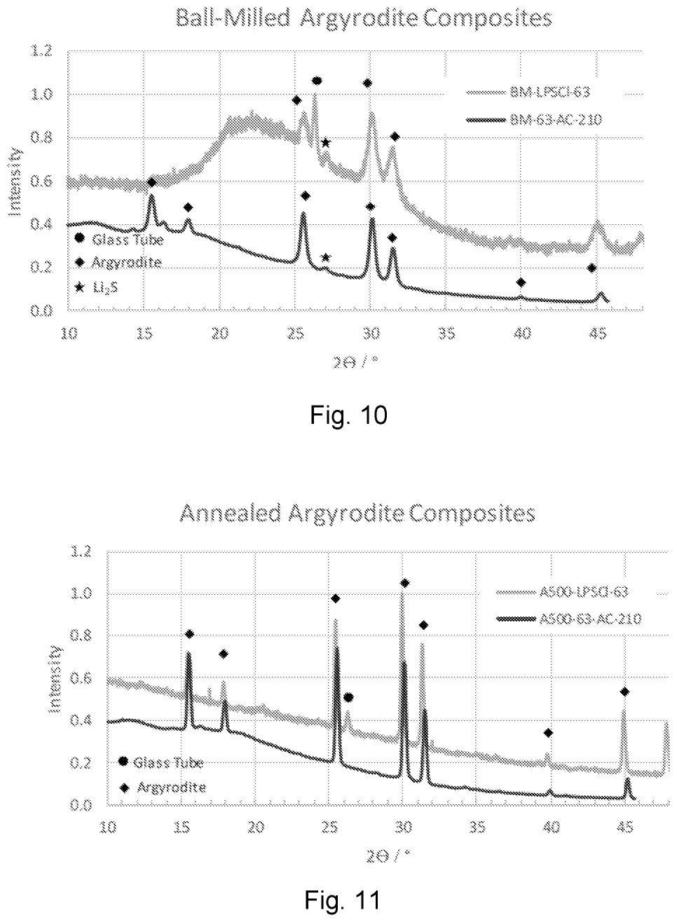

Properties of composites prepared with as-ball-milled argyrodites and after-annealing argyrodites were compared. Li₆PS₅Cl argyrodite powder was synthesized via high energy ball-milling for 63 hrs, ensuring high consumption of starting materials. XRD of BM-LPSCI-63 (FIG. 10, upper gray line) showed presence of argyrodite phase (diamond) with trace amounts of residual Li₂S (star). In comparison to BM-LPSCI-20 (FIG. 9, dotted line), the longer reaction time used in the synthesis of BM-LPSCI-63 significantly improved conversion of Li₂S and LiCl, providing practically pure argyrodite phase (diamond) (FIG. 10, upper gray line). Similarly to BM-LPSCI-20, XRD of BM-LPSCI-63 showed broad signals and uneven baseline, which indicated a small size of crystallites and significantly amorphous character of the powder. This is related to the nature of ball-milling process, which reduces the crystallinity of materials. The conductivity measured for BM-LPSCI-63 was 1.42 mS/cm—higher than 1.04 mS/cm of BM-LPSCI-20. This is associated with higher purity of argyrodite phase resulting from longer synthesis time.

BM-LPSCI-63 was incorporated into a composite containing 20 wt. % SEBS. Thermal treatment at 210° C. for 12 hrs yielded BM-63-AC-210 with conductivity of 0.24 mS/cm. Conductivities of BM-63-AC-210 and BM-20-AC-210 are practically identical, despite the differences of starting argyrodites. XRD of BM-20-AC-210 (FIG. 10, lower black line) showed narrowing of the argyrodite peaks (diamond) with peak resolution and flatter baseline than BM-LPSCI-63, confirming ‘in-situ’ sintering and crystallization of the argyrodite phase.

BM-LPSCI-63 was annealed at 500° C. for 5 hrs after synthesis to obtain A500-LPSCI-63. The obtained A500-LPSCI-63 was incorporated into A500-63-AC-210 composite, processed and characterized in an analogous way to BM-63-AC-210. Annealing of argyrodite doubled the conductivity of the powder, giving 3.08 mS/cm for A500-LPSCI-63. Using the more conductive A500-LPSCI-63 did not increase the conductivity of the composite; rather, it reduced it by 40%. This indicates the conductivity retention of annealed powder is lower and that processing to achieve higher conductivity power does not necessarily translate to higher conductivity composites. A500-63-AC-210 showed only 0.14 mS/cm in comparison to 0.24 mS/cm measured for BM-63-AC-210 (See Table A, below). XRD analysis showed minor differences between spectra of argyrodite powder A500-LPSCI-63 (FIG. 11, upper grey line) and A500-63-AC-210 composite (FIG. 11, lower black line), indicating little to no changes in the composition and crystallinity of the argyrodite. However, when compared to ball-milled argyrodite and its composite, the transformation is significant. There is no Li₂S present in A500-LPSCI-63 confirming its full transformation into argyrodite during the anneal. The baseline of A500-LPSCI-63 (FIG. 11, upper curve) is much flatter and the peaks more defined and substantially narrower than BM-LPSCI-63 (FIG. 10, upper curve), confirming the much higher crystallinity and larger crystallite size of the annealed powder.

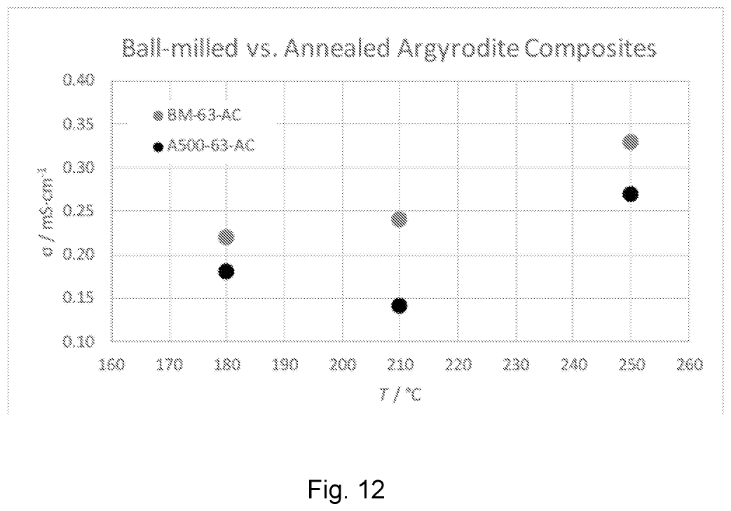

The composites prepared from BM-LPSCI-63 and A500-LPSCI-63 were pressed at 180, 210, and 250° C. The effect of the argyrodite annealing step and processing temperature on properties of composites was determined. FIG. 12 shows conductivities of thermally-processed BM-63-AC (ball-milled, gray, upper dots) and A500-63-AC (annealed, black, lower dots) composites. Composites from the annealed argyrodite are less conductive than corresponding hybrids with just-balled-milled (not annealed) materials despite the much higher conductivity of the A500-LPSCI-63 powder. Higher processing temperature resulted in increased conductivity, except for A500-63-AC-210.

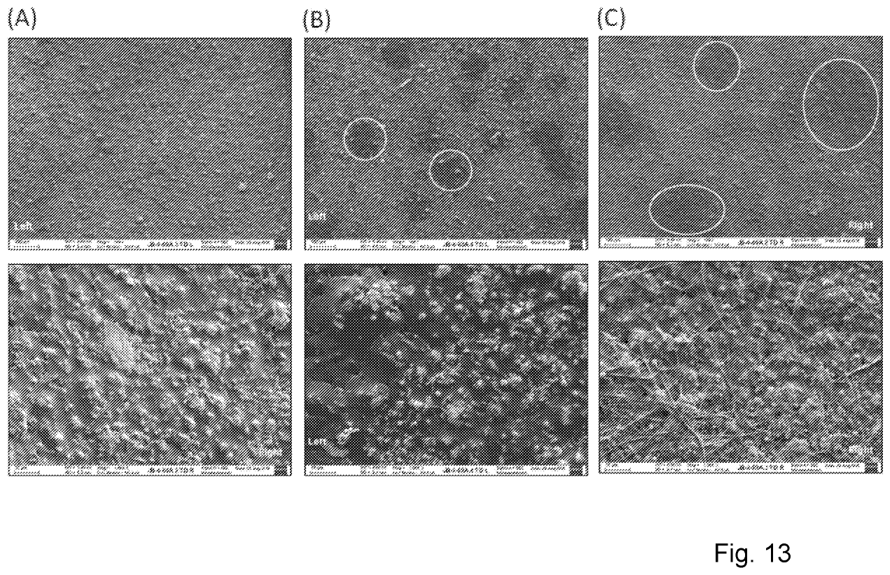

SEM imaging of the BM-63-AC composite series showed a trend between the dark, crystalline areas present and processing temperature of the composite films. FIG. 13 shows top down SEM images of the BM-63-AC-180 (column A); BM-63-AC-210 (column B); and BM-63-AC-250 (column C) composites at two different magnifications. BM-63-AC-180 shows no significant contrast difference across the surface, with multiple amorphous, micron-sized particles embedded in the film. In contrast, the composite heated at 210° C., BM-63-AC-210, shows area having a dimension on the order of 100 μm areas (circled) with distinct, crystalline character and less amorphous particles than present in other parts of the film. The crystalline patches grew even further when the film was processed at 250° C. reaching several hundred-microns in diameter. The combination of pressure and temperature induced the diffusion of the polymer to the surface and formation of long fibers across the surface of BM-63-AC-250.

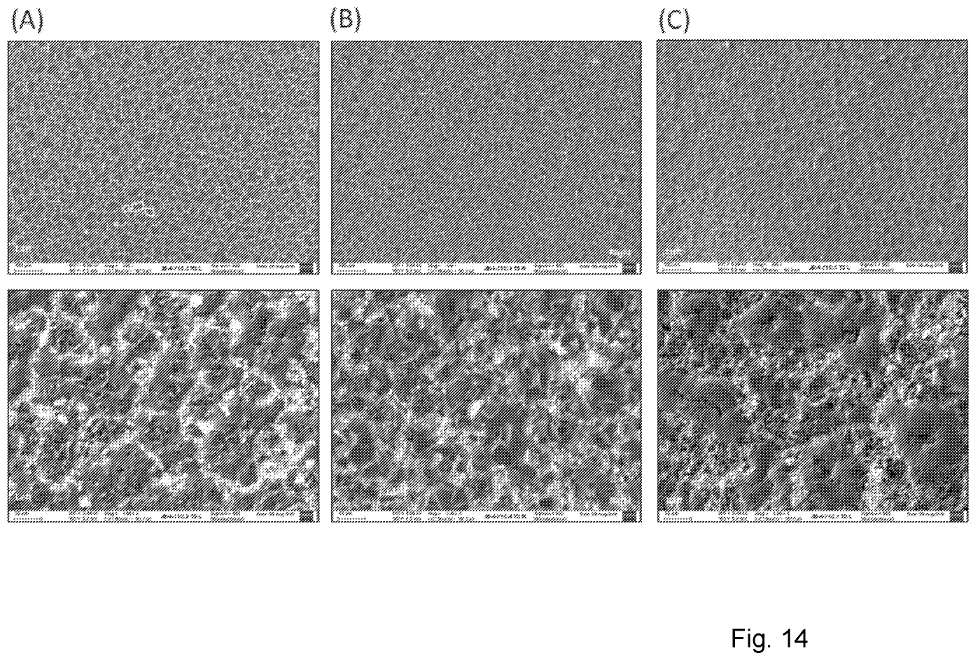

SEM imaging was performed on analogous composite series, A500-AC-63, that was prepared with annealed argyrodite A500-LPSCI-63 instead. FIG. 14 shows top-down images of A500-AC-63 composites heated at 180, 210 and 250° C., in columns A, B, and C, respectively. The morphology of the A500-AC-63 composites is vastly different than that observed for ball-milled argyrodite hybrids. The crystalline areas are smaller, 10-20 μm, and more uniformly spread across the surface. The morphology resembles a mosaic of crystals separated by grout made of amorphous solids and is independent of the processing (see top row). However, the pressing temperature had a significant effect on the microstructure of the crystalline areas, with different nanostructures visible (bottom row.)

A500-AC-63 composites show distinct polycrystalline character with mixed crystal shapes and sizes. A500-AC-63-210 (column B) appears to have the least porous substructure, as opposed to A500-AC-63-180 (column A) and A500-AC-63-250 (column C) that showed less densely packed crystallites and higher porosity. In addition, A500-AC-63-250 has a visibly rougher surface, with small, sharp crystals appearing in the areas around main crystals.

As shown by the conductivity, XRD, and SEM data collected for BM-63-AC and A500-63-AC composite series, the processing of both the inorganic conductor and the resulting composite affects the electrolyte properties.

Electrochemical studies of the composites were performed in Li|Li symmetrical cells as follows. The performance of BM-20-AC composites prepared as described in Example 1 was tested in Li|Li symmetrical cells for their ability to resist dendrites during cycling. BM-20-AC-160 film with 35 μm thickness was sandwiched between two μm lithium foils. The good adhesion between lithium and the composite was ensured by passing through calendar rollers and assessed by measuring bulk resistance of the electrolyte. BM-20-AC-160 Li|Li symmetrical cells were sealed under vacuum in pouch cells and cycled at room temperature. The cycling was done by passing 0.1 mA/cm2 current for 4 h, which corresponded to about 2 μm of lithium metal passed on each side. BM-20-AC-160 had reached >600 cycles before shorting occurred, showing very stable voltage after initial increase. When higher current density was applied, the cyclability dropped drastically. The limiting current density was relatively low, showing only several cycles before lithium dendrites appeared in BM-20-AC-160 symmetrical cells.

The limiting current density is the maximum current that can be applied in a Li|Li cell before dendrites start to grow. It is dictated by properties of the electrolyte separator such as conductivity, porosity, mechanical properties, adhesion to lithium metal, and current distribution.

BM-63-AC and A500-63-AC composites, with respective thickness of ^{˜}33 and ^{˜}30 μm, were sandwiched between lithium discs using a roller press. Cycling was performed with 0.2 mA/cm2 current density for 8 h, which corresponded to about 7-8 μm of lithium metal passed on each side of the composite film. BM-63-AC composites used argyrodite with longer synthesis times, otherwise the processing was the same as for BM-20-AC series described above. The length of synthesis affected lithium cyclability in composites made from ball-milled argyrodites, enabling 0.2 mA/cm2 current density when synthesis was extended from 20 to 63 hrs.

Table A, below, summarizes the ability of BM-63-AC and A500-63-A composites to resist dendrites by tracking the number of cycles before shorting occurred. No dependence between the conductivity and cyclability of the composite was observed. The least conductive A500-63-AC-210 showed greater cyclability than the other hybrids, evidencing that the conductivity might be a limiting factor, but it is not determinant for lithium cyclability. BM-63-AC composites prepared from ball-milled argyrodite showed a trend in cyclability scaling with processing temperature. BM-63-AC-180 lasted for only 1-2 cycles only before dendrites appeared. When processing temperature was increased to 210 or 250° C., the lifetime increased respectively, reaching 11-18 and 14-19 cycles (Table A).

TABLE A
Cycling Data for Li|Li symmetrical cells prepared from BM-63-AC and
A500-63-AC composites

| | | σᵣₜ | | Charge |
|---|---|---|---|---|
| Inorganic | Composite | (mS/cm) | No. of Cycles | (C/cm²) |
| Ball-milled (not | BM-63-AC-180 | 0.22 | 1-2 | 12-23 |
| annealed) | BM-63-AC-210 | 0.24 | 11-18 | 127-207 |
| BM-LPSCI-63 | BM-63-AC-250 | 0.33 | 14-19 | 160-219 |
| Annealed (after | A500-63-AC- | 0.18 | 11-16 | 127-184 |
| ball-milling) | 180 | | | |
| A500-LPSCI-63 | A500-63-AC- | 0.14 | 272 | 3133 |
| | 210 | | | |
| | A500-63-AC- | 0.27 | — | — |
| | 250 | | | |

The biggest effect on cyclability was observed when hybrids were prepared with argyrodite powder annealed prior to use. A500-63-AC films showed longer lifetime of Li|Li cells, with A500-63-AC-180 reaching similar number of cycles as BM-63-AC pressed at 210 or 250° C. (Table A). A particularly large difference in cyclability of lithium metal was achieved for A500-63-AC-210. It significantly outperformed other composites, reaching >270 cycles before failing, which was 15-25 times more than other hybrids. The potential of this cell during cycling with was very low, staying in 10-15 mV range. A cycling profile of the A500-63-AC-210 cell over a period of 40 days, after initial four months of cycles, showed a high level of stability with only a minor increase of potential. In contrast to the BM-63-AC series, increase of in-situ processing temperature to 250° C. did not further improve the cyclability of A500-63-AC. On contrary, despite higher pressing temperature and better conductivity of A500-63-AC-250, the composite had mechanical properties that did not allow for processing into Li|Li symmetrical cells without causing shorting.

### Example 3: Effect of Annealing Temperature of Argyrodite on Composite Electrolyte Properties

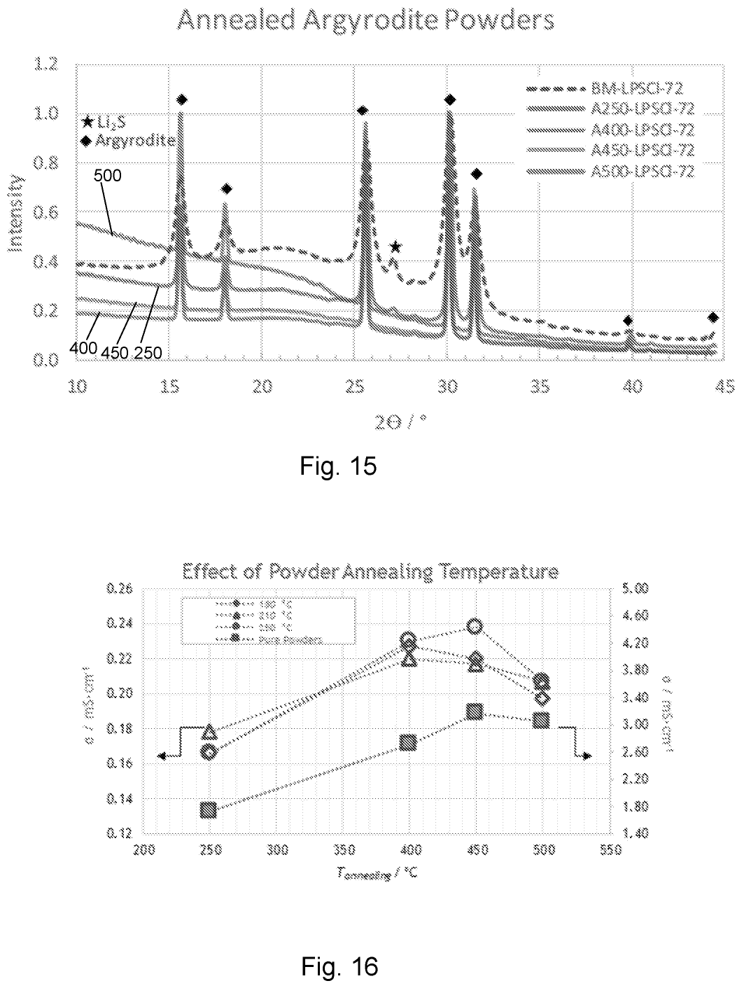

A series of argyrodites was tested in hybrids materials. Argyrodite powder, BM-LPSCI-72, was synthesized in a high-energy ball-mill for 72 hrs, and the powder was sieved to <25 μm to control the particle size. Next, as ball-milled argyrodite was annealed for 5 hrs at different temperatures: 250, 400, 450 and 500° C., obtaining A250-LPSCI-72, A400-LPSCI-72, A450-LPSCI-72 and A500-LPSCI-72. FIG. 15 shows XRD spectra of the annealed powders compared to as ball-milled argyrodite. The XRD analysis of powders shows high purity of BM-LPSCI-72 with trace amounts of residual Li₂S, small crystallite size and highly amorphous character, as indicated by the broadness of peaks and the baseline.

Annealing of BM-LPSCI-72 largely affected the crystallinity of all A-LPSCI-72 argyrodites. Heating at 250° C. was enough to induce both crystallization and sintering of argyrodite, as observed by decreased intensity of Li₂S, flattened baseline and narrower signals of A250-LPSCI-72. XRD spectrum of A400-LPSCI-72 showed disappearance of Li₂S signal, confirming its full incorporation into argyrodite phase, while showing narrowing of signals indicating sintering and growth of crystallites. In addition, processing at 400° C. produced argyrodite with the strongest intensity of peaks and the smallest baseline slope of, suggesting the highest crystallinity level among all annealed argyrodites. Ramping up temperature to 450° C. caused only small changes to the structure of A450-LPSCI-72, showing minor increase in the baseline sloping and drop of peaks intensity. In case of A500-LPSCI-72, the increase in annealing temperature by 50° C. caused a substantial steepening of the baseline, with noticeable narrowing of signals and drop in their intensity. XRD spectrum if A500-LPSCI-72 indicated that sintering was the most efficient at 500° C. as crystallites with the largest size were obtained. However a steeper baseline and decreased peaks of intensity suggested a higher fraction of amorphous phase, which evidences less effective crystallization than at lower temperatures or a thermal decomposition and formation of amorphous products such as sulfur.

Measured conductivity of BM-LPSCI-72 was 0.91 mS/cm at room temperature, and increased linearly with increasing annealing temperature, reaching 1.73, 2.71 and 3.17 mS/cm for A250-LPSCI-72, A400-LPSCI-72 and A450-LPSCI-72 respectively, then dropping slightly to 3.05 mS/cm for A500-LPSCI-72. A series of A-LPSCI-72 argyrodites were incorporated into composites with 20 wt. % SEBS as a binder, which were then hot pressed.

FIG. 16 summarizes conductivity data collected for A-72-AC composites thermally processed at 180° C. (diamond) 210° C. (triangle) and 250° C. (circle) and plotted against annealing temperature of the corresponding argyrodite. There is a direct correlation between ionic conductivity of composites and the type of argyrodite used, following practically the same trend as the one observed for the argyrodite powders (FIG. 16, full squares). On average, composites prepared from the same argyrodite but pressed at different processing temperatures showed little variation in conductivities. The ionic transport properties of composites were hardly affected by their processing temperatures, but were strongly influenced by the annealing of the argyrodite powder. Conductivities of A-250-72-AC films reached 0.16-0.18 mS/cm, then increased to 0.22-0.24 mS/cm for A-400-72-AC and A-450-72-AC, and finally dropped to 0.19-0.20 mS/cm for A-500-72-AC. That data showed that the maximum ionic conduction in composites was reached for argyrodites annealed between 400-450° C. Although the conductivity trends for pristine argyrodites and composites were very similar, the maximum conductivity performance of hybrids appeared to be shifted to lower annealing temperatures. Interestingly, that put composite conductivities on par with XRD observations, rather than conductivity of annealed powders. It shows that properties of composites are closely related to those of the starting powder, but do not necessarily follow the same trend and optimal performance at the same processing conditions.

Conductivity of crystalline thiophosphate conductors can be influenced by presence of secondary amorphous phases that might affect it in either way. Conductivity and XRD study of pristine powders showed that annealing temperature impacts crystalline/amorphous phase ratio, crystallite size, and formation of secondary phases and imperfection through decomposition reactions. In addition to conductivity measurement, the effect of annealing temperature on mechanical properties of composites was studied. The A-72-AC-210 series processed at 210° C. was the focus of the study, avoiding any variations other than the annealing temperature of pristine argyrodite. Thin composite films, about 35 μm thick, were cut into six 6 mm×50 mm strips and tested on a mini-tensile tester to ensure accuracy of measurements. Tensile testing allows for the extraction of Young's moduli, mechanical strengths, and elongations at break as parameters for assessing the mechanical properties of composites.

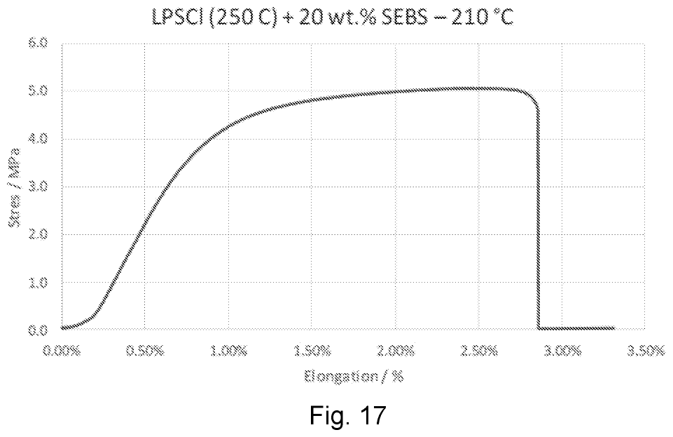

Young's (elastic) modulus represents the ability of a material to resist dimensional changes under stress (load). It is basically measured as a ratio of stress (load) to strain (elongation). The higher the modulus the stiffer the material is. Ultimate strength (tensile strength) describes the maximum capacity of a material to withstand loads that lead to its elongation. Elongation at break is the ratio of the extended length to initial length of the material after its breakage. It is related to the ability of a plastic specimen to resist changes of shape without cracking. FIG. 17 shows a stress-strain profile obtained during tensile testing of the A-250-72-AC-210 composite. The elastic modulus (Young's modulus) was calculated from the linear part of stress-strain slope, the ultimate strength was determined from the maximum stress a sample experienced, and the elongation at break was calculated from the distance grips traveled until the sample broke to the initial gauge distance.

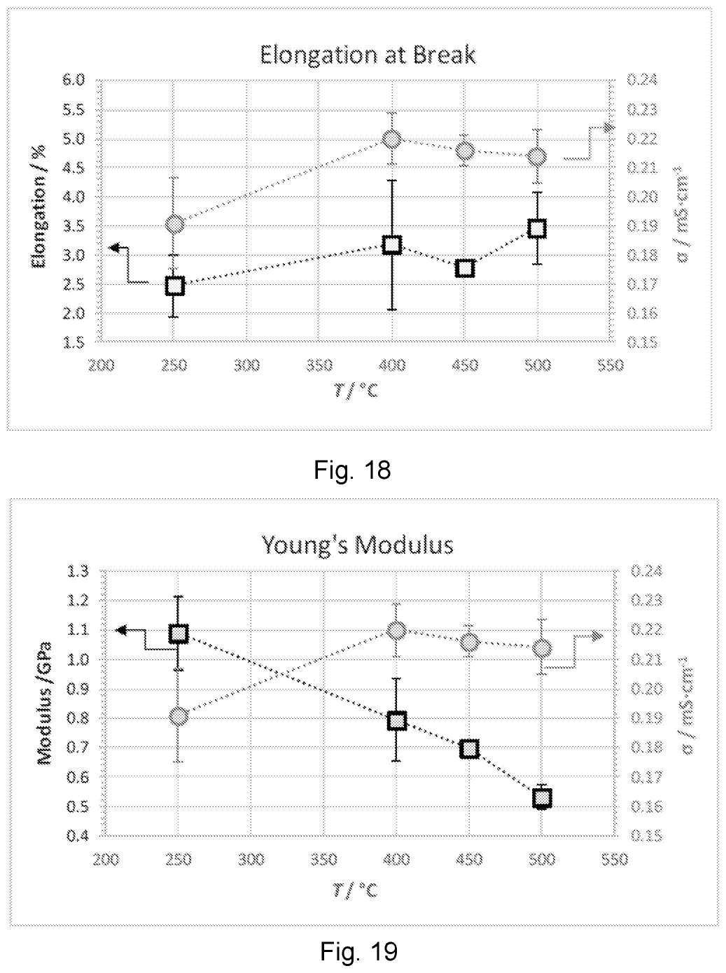

FIG. 18 shows conductivity (circles) and elongation at break (squares) of A-72-AC-210 composites vs. annealing temperature of A-LPSCI-72 argyrodite powder. It shows a small linear increase in elongation with higher annealing temperatures going from 1.5% for A-250-72-AC-210 to 2.5% for A-500-72-AC-210 suggesting more elastic behavior of the latter.

Young's moduli of composites were inversely proportional to the annealing temperature as shown in FIG. 19, which shows conductivity (circles) and Young's modulus of A-72-AC-210 composites vs. annealing temperature of A-LPSCI-72 argyrodite powder. Young's modulus reached 1.1 GPa for A-250-72-AC-210 and 0.5 GPa for A-500-72-AC-210.

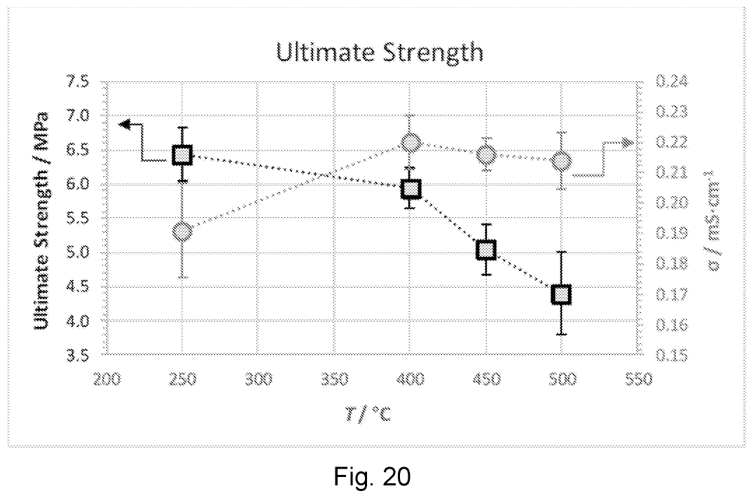

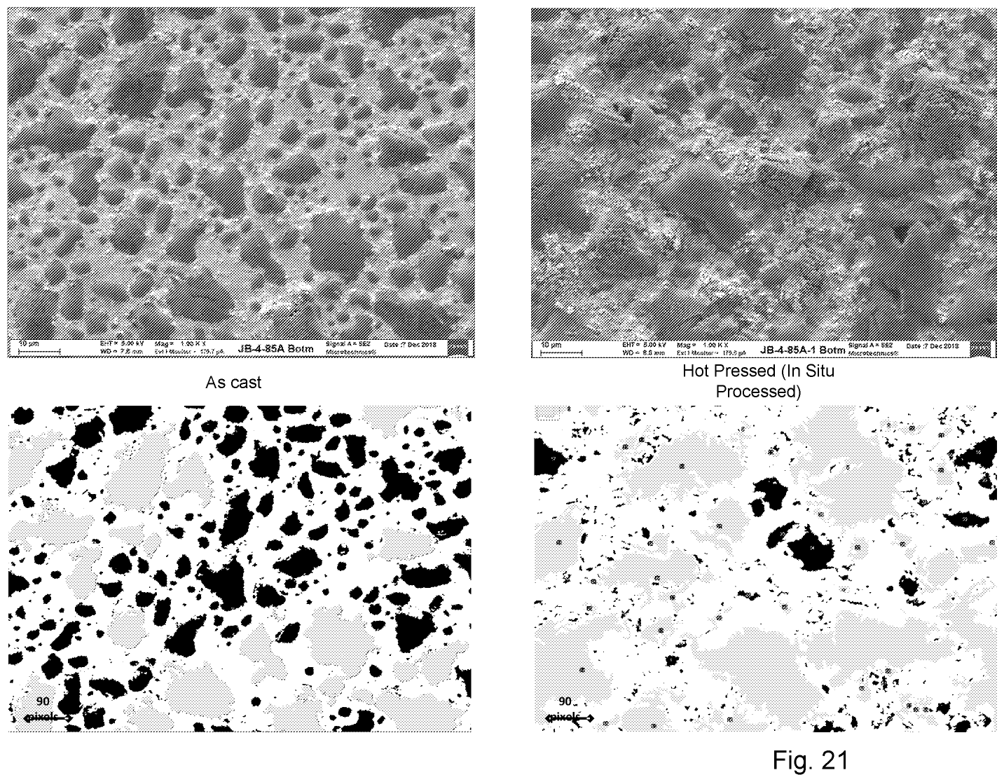

FIG. 20 shows conductivity (circles) and mechanical strength (squares) of A-72-AC-210 composites vs. annealing temperature of A-LPSCI-72 argyrodite powder. The strength values show a similar trend to Young's modulus, dropping with increasing annealing temperature, but also displaying two distinct regions. In the first region, mechanical strength was less impacted by the annealing temperature, dropping from 6.4 to 5.9 MPa for A-250-72-AC-210 and A-400-72-AC-210 respectively. However, between A-400-72-AC-210 and A-500-72-AC-210, the value plunged to 4.4 MPa.

### Example 4: Effect of Argyrodite Composition on Composite Electrolyte Properties

Films were prepared with 20 wt. % SEBS and were hot-pressed at 210° C. Table B below shows three results: two films prepared with standard (1.0 eq. LiCl) argyrodite and one with high (1.4 eq) LiCl composition. The first two data points compare standard argyrodite composition for not annealed and annealed at 450° C. powders.

The results show that modulus is doubled when powder was annealed prior to incorporation into the composite, and ultimate strength increases, but only by about 10%. Conductivities of films from not annealed and annealed powders are very similar at 0.2 mS/cm, even though the starting powders have 1 mS/cm and 3 mS/cm conductivity, respectively. The higher conductivity retention in sample from the non-annealed argyrodite may suggest that sintering/necking is more efficient.

TABLE B
Conductivities and Mechanical Properties of Composites

| | Tₐₙₙₑₐₗ | Polymer | T_{film} | Modulus | Strength | Elong. | σ_{inorg} | σ_{film} |
|---|---|---|---|---|---|---|---|---|
| Conductor | ° C. | phase | ° C. | GPa | MPa | % | mS•cm⁻¹ | mS•cm⁻¹ |
| Li₆PS₅CI | N/A | 20 wt. % | 210 | 0.317±0.060 | 4.16±0.23 | 2.85±0.10 | 1.0 | 0.194 |
| Li₆PS₅CI | 450 | SEBS | | 0.638±0.026 | 4.63±0.34 | 2.92±0.05 | 3.2 | 0.217 |
| Li_{5.6}PS_{4.6}CI_{1.4} | 450 | | | 0.990±0.100 | 5.56±0.00 | 1.77±0.53 | 6.1 | 0.433 |

The other comparison is between films prepared from argyrodite with 1.0 and 1.4 equivalent of LiCl, both annealed at 450° C. The results show that modulus is 50% and the ultimate strength ^{˜}20% higher in case of 1.4 eq. LiCl argyrodite vs. 1.0 LiCl. The conductivity doubled, consistent with the higher conductivity of 1.4 eq. LiCl argyrodite powder vs 1.0 eq LiCl. Unexpectedly, even though the conductivity retention is the same in the 1.0 LiCl and 1.4 LiCl annealed argyrodite films, the mechanical properties of the 1.4 LiCl film are significantly better. Higher modulus and strength together with lower elongation are signs of more efficient sintering in that composition.

### Example 5: Average Size, Circularity, and Solidity of In-Situ Processed Argyrodite

FIG. 21 shows SEM images of as-cast and in situ processed argyrodite containing composites (top row), with corresponding image analysis results in the row below. The films were cast using 20% SEBS and argyrodite and hot pressed for 12 hours at 210° under 24 tons load. The SEM images were analyzed using ImageJ. Table C below shows image analysis results.

TABLE C
Image analysis of composites

| | | Count | Total | Average | | | | |
|---|---|---|---|---|---|---|---|---|
| Comp- | Circularity | of | Area | particle | % | Perinnet | Circularit | Solidit |
| osite | Filter | particles | (μm²) | size(μm) | Area | er | y | y |
| As cast | 0-1 | 178 | 3698 | 21 | 41.0 | 20 | 0.627 | 0.854 |
| | 0-0.5 | 49 | 2717 | 55 | 30.1 | 46 | 0.328 | 0.755 |
| | 0-0.3 | 18 | 1734 | 96 | 19.2 | 74 | 0.213 | 0.696 |
| Hot | 0-1 | 113 | 3375 | 30 | 37.1 | 35 | 0.306 | 0.638 |
| Pressed | 0-0.5 | 96 | 3310 | 34 | 36.4 | 40 | 0.249 | 0.607 |
| | 0-0.3 | 65 | 3027 | 47 | 33.3 | 51 | 0.184 | 0.556 |

Image analysis included applying circularity filters of 0-1 (i.e., all particles), 0-0.5, and 0-0.3, with 1 representing a perfect circle. As can be seen, in-situ processing greatly reduces the circularity and increases the average particle size. The solidity, or area/convex area, is also shown. A value of 1 signifies a solid object, with smaller values indicating more irregular boundaries. The results in Table C show that the in-situ processing results in larger, less circular particles.

### Example 6: Composites with Argyrodites and Polar Binders

Argyrodite composites can be prepared with various polymeric binders, including very polar ones, as long as the process is be done without the use of polar solvents that degrade the inorganic. The table below summarizes composites prepared with 5 wt. % binders with increasing polarity, SEBS-gMA, NBR₂₀ (20% nitrile groups) and poly(vinyl acetate) (PVAc), that show conductivities between about 0.5 mS/cm and 0.7 mS/cm. There is a drop in conductivities of composites with more polar binders, but it is not as drastic as in case of glasses. Produced composites maintain good conductivities, while having better mechanical properties than non-polar binders.

| Conductor | Polymer | Cond. at 25 |
|---|---|---|
| comp. | binder | ° C./mS · cm⁻¹ |
| Li_{5.6}PS_{4.6}Cl_{1.4} | SEBS-gMA | 0.705 |
| (95 wt. %) | NBR₂₀ | 0.606 |
| | PVAc | 0.508 |

The below table shows conductivities of composites with binders including PMMA. Adding PMMA results in loss of conductivity for the LPS glass. Notably the conductivity retention is significantly higher than the sulfide glass containing composite 2.

| | | | PMMA wt. % in | | |
|---|---|---|---|---|---|
| Composite | Sulfide | SEBS wt. % in | composite, pre- | Hot press | |
| ID | electrolyte | composite | dissolved | conditions | σ_{film} (mS/cm) |
| 1 | 75Li₂S•25P₂S₅ | 10 wt. % | — | 170° C., 1 hr | 0.38 |
| 2 | | 2 wt. % | 8 wt. % | 170° C., 1 hr | .0026 |
| 5 | Li_{5.6}PS_{4.6}Cl_{1.4} | 2 wt. % | 8 wt. % | 170° C., 1 hr | 0.33 |

Composites including polar binders may be used in any of the separator and electrodes described herein.

In the description above and in the claims, numerical ranges are inclusive of the end points of the range. For example, “y is a number between 0 and 0.8” includes 0 and 0.8. Similarly, ranges represented by a dash are inclusive of the end points of the ranges.

1. A composite comprising:
inorganic ionically conductive argyrodite-containing particles; and
an organic phase comprising a polymer binder.

2. The composite of claim 1, wherein the polymer binder is polar.

3. The composite of claim 1, wherein the polymer binder is poly(vinylacetate) or nitrile butadiene rubber having up to 30% nitrile groups.

4. The composition of claim 1, wherein the polymer binder is poly(acrylonitrile-co-styrene-co-butadiene) (ABS), poly(ethylene-co-vinylacetate), poly(styrene-co-acrylonitrile) (SAN), poly(styrene-co-maleic anhydride), poly(meth)acrylates, poly(alkyene glycols), poly(butadiene-co-acrylate), poly(butadiene-co-acrylic acid-co-acrylonitrile), poly(ethylene-co-acrylates), polyethers, polyesters of dialkyl phthalates, or poly(vinyl chloride) (PVC).

5. The composite of claim 1, wherein the polymer binder insoluble in solvents having polarity indexes below 3.5.

6. The composite of claim 1, wherein the polymer binder in non-ionically-conductive.

7. The composite of claim 1, wherein the argyrodite is given by the formula: A₇₋ₓPS₆₋ₓHalₓ where A is an alkali metal and Hal is selected from chlorine (Cl), bromine (Br), and iodine (I) and 0<x≤2.

8. A method comprising:
providing a stack comprising one or more battery electrode films and a composite separator film, wherein the composite separator film comprises argyrodite particles dispersed in a polymer film; and
heating the stack under pressure to fuse argyrodite particles in the polymer film.

9. The method of claim 8, wherein the stack comprises the composite separator film sandwiched between an anode film and a cathode film.

10. The method of claim 8, wherein the heating the stack under pressure comprises calendaring the composite separator film with one or both of an anode film and a cathode film.

11. The method of claim 8, further comprising calendaring the composite separator film with at least one of the one or more battery electrode films prior to heating the stack under pressure.

12. The method of claim 8, wherein heating the stack under pressure comprises heating it to a temperature of between 80° C. to 160° C.

13. The method of claim 8, wherein the pressure is at least 10 MPa.

14. The method of claim 8, wherein heating the stack under pressure comprises heating it to a temperature greater than a glass transition temperature or melting temperature of the polymer.

15. The method of claim 8, wherein the polymer is a styrenic block copolymer.

16. The method of claim 15, wherein the styrenic block copolymer is one of styrene-ethylene/butylene-styrene (SEBS), styrene-butadiene-styrene (SBS), and styrene-isoprene-styrene (SIS).

17-37. (canceled)

38. A method comprising:
providing a composition comprising argyrodite, polymer, and a first solvent suitable for liquid phase sintering;
heating the argyrodite at a temperature of no more than 300° C. and evaporating the first solvent to form a green composite film; and
thermally annealing at a temperature greater than 300° C. the green composite under pressure to form an electrolyte film.

39. The method of claim 38, wherein annealing the film is performed without degrading the polymer.

40. The method of claim 38, further comprising pressing the film while thermally annealing it.

41. The method of claim 38, wherein the film is annealed at a temperature of no more than 550° C.

42-76. (canceled)
